(19) United States
(12) Patent Application Publication
(10) Pub. No.: US 2025/0310179 A1
(43) Pub. Date: Oct. 2, 2025

(54) Providing Access Continuity via Tenant-Specific Private Clouds

(71) Applicant: Zscaler, Inc., San Jose, CA (US)

(72) Inventor: Lidor Pergament, San Mateo, CA (US)

(73) Assignee: Zscaler, Inc., San Jose, CA (US)

(21) Appl. No.: 19/238,970

(22) Filed: Jun. 16, 2025

Related U.S. Application Data
(63) Continuation-in-part of application No. 19/008,999, filed on Jan. 3, 2025.
Application No. 19/008,999 is a continuation-in-part of application No. 18/307,303, filed on Apr. 26, 2023.
Application No. 18/307,303 is a continuation-in-part of application No. 17/154,139, filed on Jan. 21, 2021, now Pat. No. 11,962,589.
Application No. 17/154,139 is a continuation-in-part of application No. 16/922,353, filed on Jul. 7, 2020, now Pat. No. 11,533,307.

(51) Int. Cl. H04L 41/0659; H04L 43/10; H04L 67/10

(52) U.S. Cl. CPC H04L 41/0661; H04L 43/10; H04L 67/10

(57) ABSTRACT

Systems and methods for providing continued access via a tenant-specific private cloud include monitoring an operation state of a cloud-based system to detect disruptions based on predefined conditions; enabling a disaster recovery mode in response to detecting a disruption in the cloud-based system; and responsive to activation of the disaster recovery mode, redirecting traffic associated with a tenant from the cloud-based system to a tenant-specific private cloud, the tenant-specific private cloud being configured to enforce tenant-specific policies and maintain access to internet, Software-as-a-Service (SaaS) applications, and private applications.

### CROSS-REFERENCE TO RELATED APPLICATION(S)

The present patent application/patent is a continuation-in-part of U.S. patent application Ser. No. 19/008,999, filed Jan. 3, 2025, and entitled “Disaster recovery for private application access continuity,” which is a continuation-in-part of U.S. patent application Ser. No. 18/307,303, filed Apr. 26, 2023, and entitled “Disaster recovery for cloud-based monitoring of internet access,” which is a continuation-in-part of U.S. patent application Ser. No. 17/154,139, filed Jan. 21, 2021, and entitled “Disaster recovery for a cloud-based security service,” which is a continuation-in-part of U.S. patent application Ser. No. 16/922,353, filed Jul. 7, 2020, and entitled “Enforcing security policies on mobile devices in a hybrid architecture,” the contents of each are incorporated by reference herein in their entirety.

### FIELD OF THE DISCLOSURE

The present disclosure generally relates to computer networking systems and methods. More particularly, the present disclosure relates to systems and methods for providing access continuity via tenant-specific private clouds.

### BACKGROUND OF THE DISCLOSURE

Modern businesses increasingly rely on cloud-based platforms to host critical applications, manage workflows, and enable seamless access to internet resources, Software-as-a-Service (Saas) applications, and private enterprise systems. These platforms, typically provided by public cloud services/platforms, offer scalable infrastructure, centralized management, and cost-efficiency. However, reliance on public cloud systems introduces vulnerabilities, such as outages, attacks, and disruptions, that can severely impact business continuity. Despite the availability of Disaster Recovery (DR) solutions, traditional systems often sacrifice security, functionality, or efficiency during failover states. For instance, many DR models focus solely on data backup and restoration but fail to provide immediate, policy-enforced operational continuity for active applications.

### BRIEF SUMMARY OF THE DISCLOSURE

In various embodiments, the present disclosure includes a method implementing steps, a cloud-based system configured to implement the steps, and the steps as computer-executable instructions stored in a non-transitory computer-readable medium. The steps include monitoring an operation state of a cloud-based system to detect disruptions based on predefined conditions; enabling a disaster recovery mode in response to detecting a disruption in the cloud-based system; and responsive to activation of the disaster recovery mode, redirecting traffic associated with a tenant from the cloud-based system to a tenant-specific private cloud, the tenant-specific private cloud being configured to enforce tenant-specific policies and maintain access to internet, Software-as-a-Service (SaaS) applications, and private applications.

The steps can further include wherein prior to activation of disaster recovery mode, the access is provided through the cloud-based system, and after activation of disaster recovery mode, the access is provided through the tenant-specific private cloud, wherein the tenant-specific private cloud includes a private node, a private policy cache, and a private cloud controller. Monitoring the operation state of the cloud-based system can include performing periodic health checks with heartbeat signals and detecting disruptions by evaluating response timeout thresholds and error conditions. The steps can include synchronizing tenant-specific policies and configurations between the cloud-based system and the tenant-specific private cloud. Redirecting traffic can include modifying Domain Name Service (DNS) records to route tenant traffic to a Fully Qualified Domain Name (FQDN) associated with the tenant-specific private cloud. The steps can include authenticating users and devices accessing the tenant-specific private cloud and providing least-privilege access controls for private applications via the private cloud. The tenant-specific private cloud can be configured to provide authentication services, facilitate load balancing among private cloud resources, stream activity logs from the private cloud to a storage solution, and synchronize policies and configurations with the cloud-based system while disaster recovery mode is inactive. The steps can include detecting restoration of the cloud-based system and initiating a failback procedure to redirect tenant traffic from the tenant-specific private cloud back to the cloud-based system. The failback procedure can synchronize logs, configurations, and policies from the tenant-specific private cloud to the cloud-based system before redirection. The steps can include providing access to private applications of the tenant through one or more application connectors, wherein the one or more application connectors are adapted to facilitate a connection through a private cloud controller of the tenant specific private cloud.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of a cloud-based system offering security as a service;

FIG. 2 is a network diagram of an example implementation of the cloud-based system;

FIG. 3 is a block diagram of a server that may be used in the cloud-based system of FIGS. 1 and 2 or the like;

FIG. 4 is a block diagram of a user device that may be used with the cloud-based system of FIGS. 1 and 2 or the like;

FIG. 5 is a network diagram of the cloud-based system illustrating an application on user devices with users configured to operate through the cloud-based system;

FIG. 6 is a network diagram of a Zero Trust Network Access (ZTNA) application utilizing the cloud-based system of FIGS. 1 and 2;

FIG. 7 is a network diagram of the cloud-based system of FIGS. 1 and 2 in an application of digital experience monitoring;

FIG. 8 is a network diagram of a unified agent application and associated connectivity and functionality with the cloud-based system;

FIG. 9 is a network diagram of example workflow of the unified agent application;

FIG. 10 is a flow diagram of an event sequence associated with the unified agent application;

FIG. 11 is a logical diagram of functional components of the unified agent application;

FIG. 12 is a flowchart of a proxy authentication process to the cloud-based system;

FIG. 13 is a flowchart of a VPN authentication process to the cloud-based system;

FIG. 14 is a flowchart of a device enrollment process for the client user device and the unified agent application;

FIG. 15 is a flowchart of a traffic interception process implemented through the unified agent application;

FIG. 16 is a flow diagram of traffic interception and splitting using the unified agent application;

FIG. 17 is a flow diagram of tunnel forwarding rules by the unified agent application;

FIG. 18 is a flowchart of a service drive split tunneling process;

FIG. 19 is a flowchart of a process for security processing in a hybrid architecture;

FIG. 20 is a flowchart of a process for disaster recovery via the hybrid architecture of FIG. 19;

FIG. 21 is an embodiment of a disaster recovery configuration page;

FIG. 22 is a network diagram of the cloud-based system during activation of disaster recovery;

FIG. 23 is a network diagram of private broker disaster recovery components;

FIG. 24 is a flow chart of a process for disaster recovery for cloud-based monitoring of internet access;

FIG. 25 is a flow chart of a process for disaster recovery for cloud-based private application access.

FIG. 26 is a flow diagram depicting a customer having a plurality of sites, each site having an on-site disaster recovery system.

FIG. 27 is a flow chart of a process for providing private application access continuity.

FIG. 28 is a diagram of an architecture for providing access to the internet and SaaS applications via a private cloud.

FIG. 29 is a diagram of an architecture for providing access to private applications via a private cloud.

FIG. 30 is a flowchart of a process for providing access continuity via tenant-specific private clouds.

### DETAILED DESCRIPTION OF THE DISCLOSURE

The present disclosure introduces a “hosted private cloud” infrastructure tailored to individual tenants, offering secure, fault-isolated operations, automated failover and failback mechanisms, and access to comprehensive private and public resources under predefined configurations and protections. By integrating advanced disaster recovery capabilities and ensuring seamless transitions during outages, the invention redefines cloud resilience and empowers businesses to maintain productivity without compromise.

Additionally, the present disclosure relates to systems and methods for disaster recovery for cloud-based private application access. Various embodiments include the utilization of on-site disaster recovery systems to provide access to private applications if there is an occurrence of a cloud outage.

Additionally, the present disclosure relates to systems and methods for disaster recovery for a cloud-based security service. In particular, the disaster recovery can include a hybrid architecture. In particular, the hybrid architecture is one where there is some client-side processing of security functions and some cloud-based processing, in conjunction with one another. The objective is to leverage the benefits of both approaches while reducing or eliminating the shortcomings. The present disclosure includes a lightweight agent or application (“client connector”) that is executed on mobile devices with the agent supporting application firewall, Uniform Resource Locator (URL) filtering, Data Loss Prevention (DLP), etc. Further, the lightweight agent or application is synchronized with a cloud-based security system for updates, processing in the cloud, etc. This approach with a hybrid architecture enforces security policies on a mobile device while leveraging the cloud in an efficient and optimized manner. For disaster recovery, the lightweight agent or application can be used to cache user activity for local policy, such as based on user browsing, and use the cached local policy in a failure scenario. Thus, there can be security processing without the cloud-based system and without failing open (with no security processing).

Additionally, the present disclosure relates to systems and methods for service driven split tunneling of mobile network traffic. The systems and methods include an app or agent on a user device (e.g., a mobile device) which performs split tunneling based upon port, protocol, and destination IP address instead of just destination IP. This provides granular controls to IT administrators to steer a user's network traffic based upon the demands of the service. This is very advantageous from a scalability point of view as the demands for a particular service grow, that traffic can be individually distributed, load-balanced, and served without impacting traffic of other services. This form of split tunneling also allows for efficient usage of resources both on the end user's device as well as backend concentrators. For instance, if all traffic, including HTTP and HTTPS, is tunneled via an SSL VPN, there is an overhead of decrypting SSL traffic twice, one for the transport and the other for the application itself. While splitting traffic based upon the protocol, the HTTPS transport can go unencrypted since the HTTPS traffic itself is encrypted. This saves both the client and the avoiding encryption and decryption twice, saving a significant amount of computational power on all ends.

Another benefit of this form of split tunneling is that it takes into account the quality of service requirements for different protocols. For example, in a conventional VPN, all VOIP and UDP traffic will be tunneled over an SSL VPN with all other TCP traffic as well. Since all these protocols have different service requirements, the traditional VPN generally underperforms and is difficult to scale. With this service driven split tunneling, VOIP over UDP traffic can be tunneled separately to a specific UDP traffic concentrator that is designed for handling large volumes of such traffic. In this case, VOIP traffic does not need to fight with other protocols through its intended destination. In another use case, an admin may altogether decide not to tunnel VOIP traffic and go directly from the user's device. Note that this kind of granularity is not possible with split tunneling based upon destination IP address alone. The service driven split tunneling further allows for on-demand embarking (or disembarking) of particular network traffic, i.e., whenever the IT infrastructure is ready to support a new protocol, the agent can start (or stop) tunneling that traffic based upon the configured rules.

Further, the present disclosure relates to systems and methods for cloud-based unified service discovery and secure availability. The systems and methods enable a user to connect to multiple cloud services through the dynamic discovery of available services, followed by authentication and access as exposed in the corresponding service protocol. The systems and methods address the unmanageable growth of mobility and cloud-based services, which have led to a proliferation of individual applications for access to individual services. The systems and method can be implemented through a mobile application (“app”) which overcomes the hassle of deploying and managing several applications across a gamut of mobile devices, operating systems, and mobile networks to gain secure access to the cloud-based Internet or intranet resources. The mobile application can uniquely perform a Dynamic evaluation of Network and Service Discovery, Unified Enrollment to all services, application-dependent service enablement, Service protocol learning, Service Availability through secure network traffic forwarding tunnels, and the like.

Again, enterprises have a strong need to provide secure access to cloud services to its end users. The growth of mobility and cloud in the IT enterprise has made it impossible for IT admins to deploy individual applications for individual services. The mobile app associated with the systems and methods overcomes these limitations through the dynamic discovery of available services to the end user, followed by authentication and access to individual services. Further, the mobile app insightfully learns the protocol for each service and establishes a secure tunnel to the service. In essence, the mobile app is one app that an enterprise may use to provide secure connectivity to the Internet and diversified internal corporate applications. At the time of user enrollment, the mobile app will discover all services provided by the enterprise cloud and will enroll the user in all of those services. It will then set up secure tunnels for each service depending upon the port, protocol, and intended destination of requested traffic.

The mobile app will also discover all applications provided within the enterprise cloud along with a Global VPN (GVPN) service and show the available services to end users. Endpoint Applications today provide one service for a specific network function (such as a VPN to a corporate network, web security, antivirus to access the Internet). The mobile app can be used to enable all these services with single enrollment. The mobile app will provide services to darknet applications along with securing the Internet traffic. The mobile app can set up a local network on the mobile device.

### Example Cloud-Based System Architecture

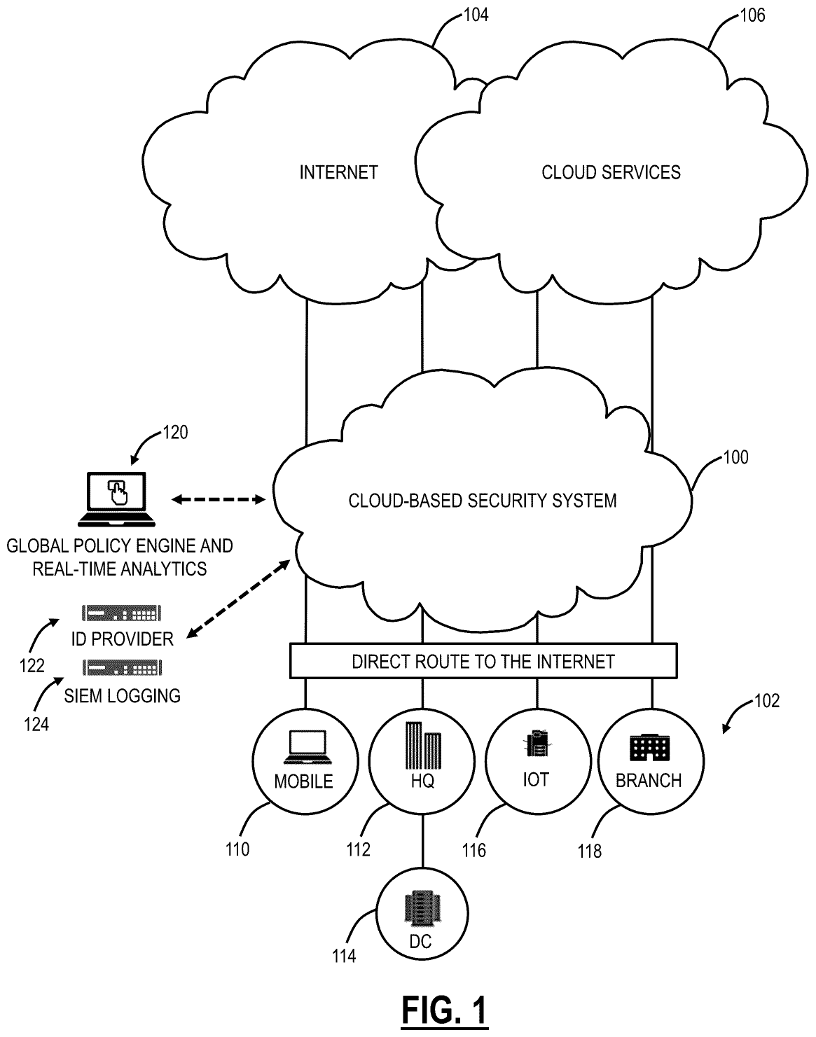

FIG. 1 is a network diagram of a cloud-based system 100 offering security as a service. Specifically, the cloud-based system 100 can offer a Secure Internet and Web Gateway as a service to various users 102, as well as other cloud services. In this manner, the cloud-based system 100 is located between the users 102 and the Internet as well as any cloud services 106 (or applications) accessed by the users 102. As such, the cloud-based system 100 provides inline monitoring inspecting traffic between the users 102, the Internet 104, and the cloud services 106, including Secure Sockets Layer (SSL) traffic. The cloud-based system 100 can offer access control, threat prevention, data protection, etc. The access control can include a cloud-based firewall, cloud-based intrusion detection, Uniform Resource Locator (URL) filtering, bandwidth control, Domain Name System (DNS) filtering, etc. The threat prevention can include cloud-based intrusion prevention, protection against advanced threats (malware, spam, Cross-Site Scripting (XSS), phishing, etc.), cloud-based sandbox, antivirus, DNS security, etc. The data protection can include Data Loss Prevention (DLP), cloud application security such as via Cloud Access Security Broker (CASB), file type control, etc.

The cloud-based firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The cloud-based intrusion prevention and advanced threat protection can deliver full threat protection against malicious content such as browser exploits, scripts, identified botnets and malware callbacks, etc. The cloud-based sandbox can block zero-day exploits (just identified) by analyzing unknown files for malicious behavior. Advantageously, the cloud-based system 100 is multi-tenant and can service a large volume of the users 102. As such, newly discovered threats can be promulgated throughout the cloud-based system 100 for all tenants practically instantaneously. The antivirus protection can include antivirus, antispyware, antimalware, etc. protection for the users 102, using signatures sourced and constantly updated. The DNS security can identify and route command-and-control connections to threat detection engines for full content inspection.

The DLP can use standard and/or custom dictionaries to continuously monitor the users 102, including compressed and/or SSL-encrypted traffic. Again, being in a cloud implementation, the cloud-based system 100 can scale this monitoring with near-zero latency on the users 102. The cloud application security can include CASB functionality to discover and control user access to known and unknown cloud services 106. The file type controls enable true file type control by the user, location, destination, etc. to determine which files are allowed or not.

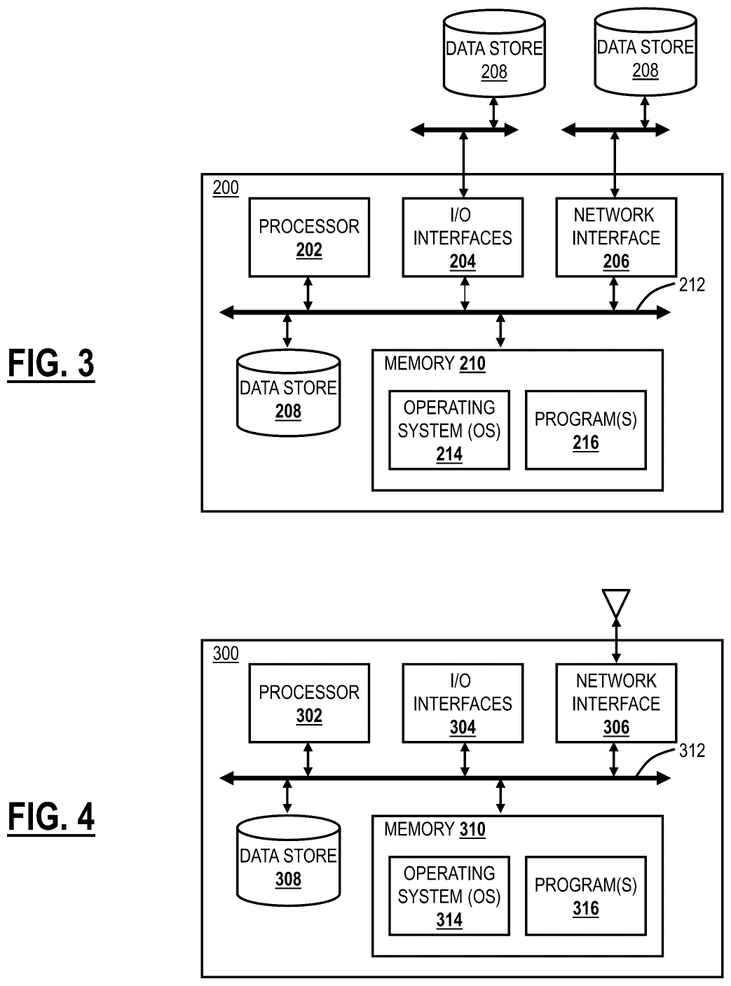

For illustration purposes, the users 102 of the cloud-based system 100 can include a mobile device 110, a headquarters (HQ) 112 which can include or connect to a data center (DC) 114, Internet of Things (IoT) devices 116, a branch office/remote location 118, etc., and each includes one or more user devices (an example user device 300 is illustrated in FIG. 3). The devices 110, 116, and the locations 112, 114, 118 are shown for illustrative purposes, and those skilled in the art will recognize there are various access scenarios and other users 102 for the cloud-based system 100, all of which are contemplated herein. The users 102 can be associated with a tenant, which may include an enterprise, a corporation, an organization, etc. That is, a tenant is a group of users who share a common access with specific privileges to the cloud-based system 100, a cloud service, etc. In an embodiment, the headquarters 112 can include an enterprise's network with resources in the data center 114. The mobile device 110 can be a so-called road warrior, i.e., users that are off-site, on-the-road, etc.

Further, the cloud-based system 100 can be multi-tenant, with each tenant having its own users 102 and configuration, policy, rules, etc. One advantage of the multi-tenancy and a large volume of users is the zero-day/zero-hour protection in that a new vulnerability can be detected and then instantly remediated across the entire cloud-based system 100. The same applies to policy, rule, configuration, etc. changes—they are instantly remediated across the entire cloud-based system 100. As well, new features in the cloud-based system 100 can also be rolled up simultaneously across the user base, as opposed to selective and time-consuming upgrades on every device at the locations 112, 114, 118, and the devices 110, 116.

Logically, the cloud-based system 100 can be viewed as an overlay network between users (at the locations 112, 114, 118, and the devices 110, 116) and the Internet 104 and the cloud services 106. Previously, the IT deployment model included enterprise resources and applications stored within the data center 114 (i.e., physical devices) behind a firewall (perimeter), accessible by employees, partners, contractors, etc. on-site or remote via Virtual Private Networks (VPNs), etc. The cloud-based system 100 is replacing the conventional deployment model. The cloud-based system 100 can be used to implement these services in the cloud without requiring the physical devices and management thereof by enterprise IT administrators. As an ever-present overlay network, the cloud-based system 100 can provide the same functions as the physical devices and/or appliances regardless of geography or location of the users 102, as well as independent of platform, operating system, network access technique, network access provider, etc.

There are various techniques to forward traffic between the users 102 at the locations 112, 114, 118, and via the devices 110, 116, and the cloud-based system 100. Typically, the locations 112, 114, 118 can use tunneling where all traffic is forward through the cloud-based system 100. For example, various tunneling protocols are contemplated, such as Generic Routing Encapsulation (GRE), Layer Two Tunneling Protocol (L2TP), Internet Protocol (IP) Security (IPsec), customized tunneling protocols, etc. The devices 110, 116, when not at one of the locations 112, 114, 118 can use a local application that forwards traffic, a proxy such as via a Proxy Auto-Config (PAC) file, and the like. A key aspect of the cloud-based system 100 is all traffic between the users 102 and the Internet 104 or the cloud services 106 is via the cloud-based system 100. As such, the cloud-based system 100 has visibility to enable various functions, all of which are performed off the user device in the cloud.

The cloud-based system 100 can also include a management system 120 for tenant access to provide global policy and configuration as well as real-time analytics. This enables IT administrators to have a unified view of user activity, threat intelligence, application usage, etc. For example, IT administrators can drill-down to a per-user level to understand events and correlate threats, to identify compromised devices, to have application visibility, and the like. The cloud-based system 100 can further include connectivity to an Identity Provider (IDP) 122 for authentication of the users 102 and to a Security Information and Event Management (SIEM) system 124 for event logging. The system 124 can provide alert and activity logs on a per-user 102 basis.

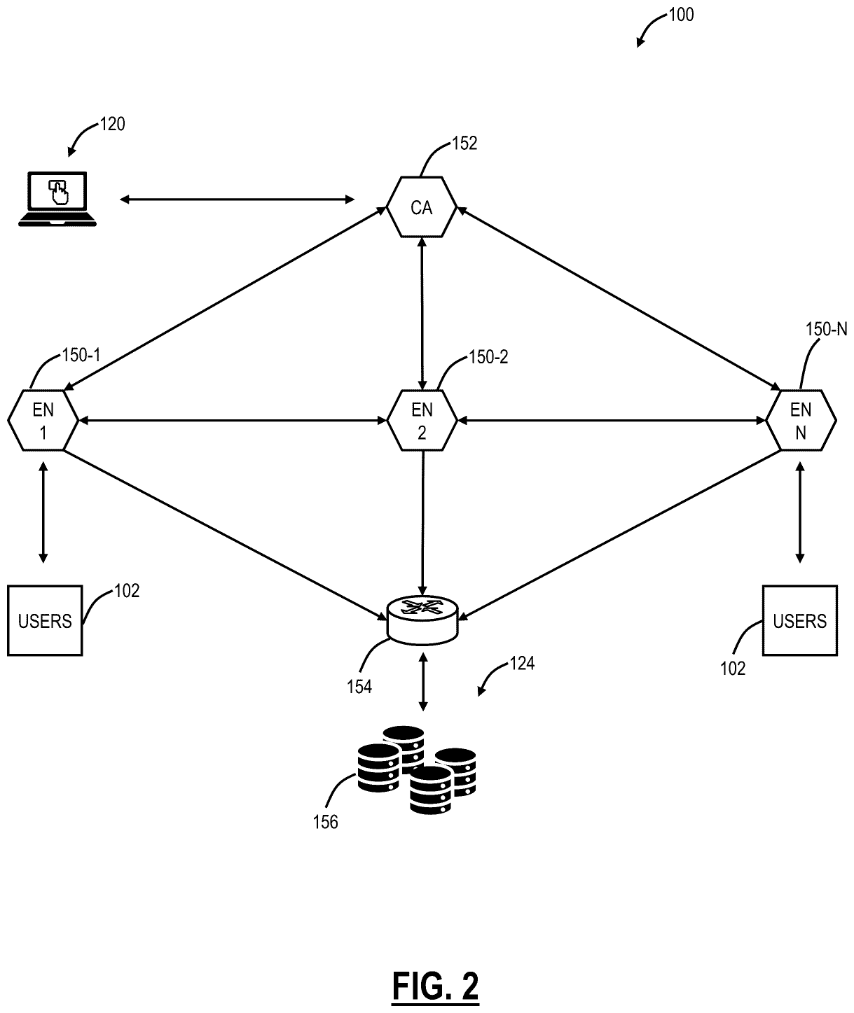

FIG. 2 is a network diagram of an example implementation of the cloud-based system 100. In an embodiment, the cloud-based system 100 includes a plurality of enforcement nodes (EN) 150, labeled as enforcement nodes 150-1, 150-2, 150-N, interconnected to one another and interconnected to a central authority (CA152). The nodes 150, 152, while described as nodes, can include one or more servers, including physical servers, virtual machines (VM) executed on physical hardware, etc. An example of a server is illustrated in FIG. 2. The cloud-based system 100 further includes a log router 154 that connects to a storage cluster 156 for supporting log maintenance from the enforcement nodes 150. The central authority 152 provide centralized policy, real-time threat updates, etc. and coordinates the distribution of this data between the enforcement nodes 150. The enforcement nodes 150 provide an onramp to the users 102 and are configured to execute policy, based on the central authority 152, for each user 102. The enforcement nodes 150 can be geographically distributed, and the policy for each user 102 follows that user 102 as he or she connects to the nearest (or other criteria) enforcement node 150. Of note, the cloud-based system is an external system meaning it is separate from tenant's private networks (enterprise networks) as well as from networks associated with the devices 110, 116, and locations 112, 118.

The enforcement nodes 150 are full-featured secure internet gateways that provide integrated internet security. They inspect all web traffic bi-directionally for malware and enforce security, compliance, and firewall policies, as described herein. In an embodiment, each enforcement node 150 has two main modules for inspecting traffic and applying policies: a web module and a firewall module. The enforcement nodes 150 are deployed around the world and can handle hundreds of thousands of concurrent users with millions of concurrent sessions. Because of this, regardless of where the users 102 are, they can access the Internet 104 from any device, and the enforcement nodes 150 protect the traffic and apply corporate policies. The enforcement nodes 150 can implement various inspection engines therein, and optionally, send sandboxing to another system. The enforcement nodes 150 include significant fault tolerance capabilities, such as deployment in active-active mode to ensure availability and redundancy as well as continuous monitoring.

In an embodiment, customer traffic is not passed to any other component within the cloud-based system 100, and the enforcement nodes 150 can be configured never to store any data to disk. Packet data is held in memory for inspection and then, based on policy, is either forwarded or dropped. Log data generated for every transaction is compressed, tokenized, and exported over secure TLS connections to the log routers 154 that direct the logs to the storage cluster 156, hosted in the appropriate geographical region, for each organization. In an embodiment, all data destined for or received from the Internet is processed through one of the enforcement nodes 150. In another embodiment, specific data specified by each tenant, e.g., only email, only executable files, etc., is process through one of the enforcement nodes 150.

Each of the enforcement nodes 150 may generate a decision vector D=[d1, d2, . . . , dn] for a content item of one or more parts C=[c1, c2, . . . , cm]. Each decision vector may identify a threat classification, e.g., clean, spyware, malware, undesirable content, innocuous, spam email, unknown, etc. For example, the output of each element of the decision vector D may be based on the output of one or more data inspection engines. In an embodiment, the threat classification may be reduced to a subset of categories, e.g., violating, non-violating, neutral, unknown. Based on the subset classification, the enforcement node 150 may allow the distribution of the content item, preclude distribution of the content item, allow distribution of the content item after a cleaning process, or perform threat detection on the content item. In an embodiment, the actions taken by one of the enforcement nodes 150 may be determinative on the threat classification of the content item and on a security policy of the tenant to which the content item is being sent from or from which the content item is being requested by. A content item is violating if, for any part C=[c1, c2, . . . , cm] of the content item, at any of the enforcement nodes 150, any one of the data inspection engines generates an output that results in a classification of “violating.”

The central authority 152 hosts all customer (tenant) policy and configuration settings. It monitors the cloud and provides a central location for software and database updates and threat intelligence. Given the multi-tenant architecture, the central authority 152 is redundant and backed up in multiple different data centers. The enforcement nodes 150 establish persistent connections to the central authority 152 to download all policy configurations. When a new user connects to an enforcement node 150, a policy request is sent to the central authority 152 through this connection. The central authority 152 then calculates the policies that apply to that user 102 and sends the policy to the enforcement node 150 as a highly compressed bitmap.

The policy can be tenant-specific and can include access privileges for users, websites and/or content that is disallowed, restricted domains, DLP dictionaries, etc. Once downloaded, a tenant's policy is cached until a policy change is made in the management system 120. The policy can be tenant-specific and can include access privileges for users, websites and/or content that is disallowed, restricted domains, DLP dictionaries, etc. When this happens, all of the cached policies are purged, and the enforcement nodes 150 request the new policy when the user 102 next makes a request. In an embodiment, the enforcement node 150 exchange “heartbeats” periodically, so all enforcement nodes 150 are informed when there is a policy change. Any enforcement node 150 can then pull the change in policy when it sees a new request.

The cloud-based system 100 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software as a Service” (SaaS) is sometimes used to describe application programs offered through cloud computing. A common shorthand for a provided cloud computing service (or even an aggregation of all existing cloud services) is “the cloud.” The cloud-based system 100 is illustrated herein as an example embodiment of a cloud-based system, and other implementations are also contemplated.

As described herein, the terms cloud services and cloud applications may be used interchangeably. The cloud service 106 is any service made available to users on-demand via the Internet, as opposed to being provided from a company's on-premises servers. A cloud application, or cloud app, is a software program where cloud-based and local components work together. The cloud-based system 100 can be utilized to provide example cloud services, including Zscaler Internet Access (ZIA), Zscaler Private Access (ZPA), and Zscaler Digital Experience (ZDX), all from Zscaler, Inc. (the assignee and applicant of the present application). The ZIA service can provide the access control, threat prevention, and data protection described above with reference to the cloud-based system 100. ZPA can include access control, microservice segmentation, etc. The ZDX service can provide monitoring of user experience, e.g., Quality of Experience (QoE), Quality of Service (QOS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services 106 are also contemplated. Also, other types of cloud architectures are also contemplated, with the cloud-based system 100 presented for illustration purposes.

### Example Server Architecture

FIG. 3 is a block diagram of a server 200, which may be used in the cloud-based system 100, in other systems, or standalone. For example, the enforcement nodes 150 and the central authority 152 may be formed as one or more of the servers 200. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 3 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof.

Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

### Example User Device Architecture

FIG. 4 is a block diagram of a user device 300, which may be used with the cloud-based system 100 or the like. Specifically, the user device 300 can form a device used by one of the users 102, and this may include common devices such as laptops, smartphones, tablets, netbooks, personal digital assistants, MP3 players, cell phones, e-book readers, IoT devices, servers, desktops, printers, televisions, streaming media devices, and the like. The present disclosure relates to mobile devices, which are one subset of the user device 300. The user device 300 can be a digital device that, in terms of hardware architecture, generally includes a processor 302, I/O interfaces 304, a network interface 306, a data store 308, and memory 310. It should be appreciated by those of ordinary skill in the art that FIG. 4 depicts the user device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the user device 300, a semiconductor-based microprocessor (in the form of a microchip or chipset), or generally any device for executing software instructions. When the user device 300 is in operation, the processor 302 is configured to execute software stored within the memory 310, to communicate data to and from the memory 310, and to generally control operations of the user device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the user device 300. For example, example programs 316 may include, but not limited to, a web browser, social networking applications, streaming media applications, games, mapping and location applications, electronic mail applications, financial applications, and the like. In a typical example, the end-user typically uses one or more of the programs 316 along with a network such as the cloud-based system 100.

### User Device Application for Traffic Forwarding and Monitoring

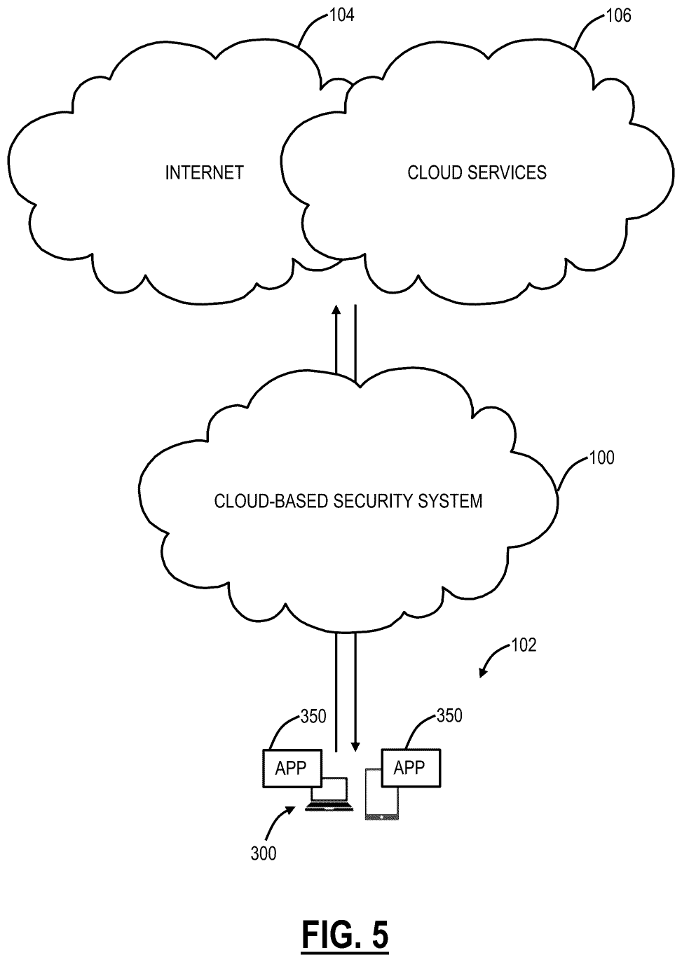

FIG. 5 is a network diagram of the cloud-based system 100 illustrating an application 350 on user devices 300 with users 102 configured to operate through the cloud-based system 100. Different types of user devices 300 are proliferating, including Bring Your Own Device (BYOD) as well as IT-managed devices. The conventional approach for a user device 300 to operate with the cloud-based system 100 as well as for accessing enterprise resources includes complex policies, VPNs, poor user experience, etc. The application 350 can automatically forward user traffic with the cloud-based system 100 as well as ensuring that security and access policies are enforced, regardless of device, location, operating system, or application. The application 350 automatically determines if a user 102 is looking to access the open Internet 104, a SaaS app, or an internal app running in public, private, or the datacenter and routes mobile traffic through the cloud-based system 100. The application 350 can support various cloud services, including ZIA, ZPA, ZDX, etc., allowing the best in class security with zero trust access to internal apps. For example, the application 350 can be referred to as a “client connector,” enabling the user device 300 to connect to cloud services.

The application 350 is configured to auto-route traffic for a seamless user experience. This can be protocol as well as application-specific, and the application 350 can route traffic with a nearest or best fit enforcement node 150. Further, the application 350 can detect trusted networks, allowed applications, etc. and support secure network access. The application 350 can also support the enrollment of the user device 300 prior to accessing applications. The application 350 can uniquely detect the users 102 based on fingerprinting the user device 300, using criteria like device model, platform, operating system, etc. The application 350 can support Mobile Device Management (MDM) functions, allowing IT personnel to deploy and manage the user devices 300 seamlessly. This can also include the automatic installation of client and SSL certificates during enrollment. Finally, the application 350 provides visibility into device and app usage of the user 102 of the user device 300.

The application 350 supports a secure, lightweight tunnel between the user device 300 and the cloud-based system 100. For example, the lightweight tunnel can be HTTP-based. With the application 350, there is no requirement for PAC files, an IPSec VPN, authentication cookies, or end user 102 setup.

### Zero Trust Network Access Using the Cloud-Based System

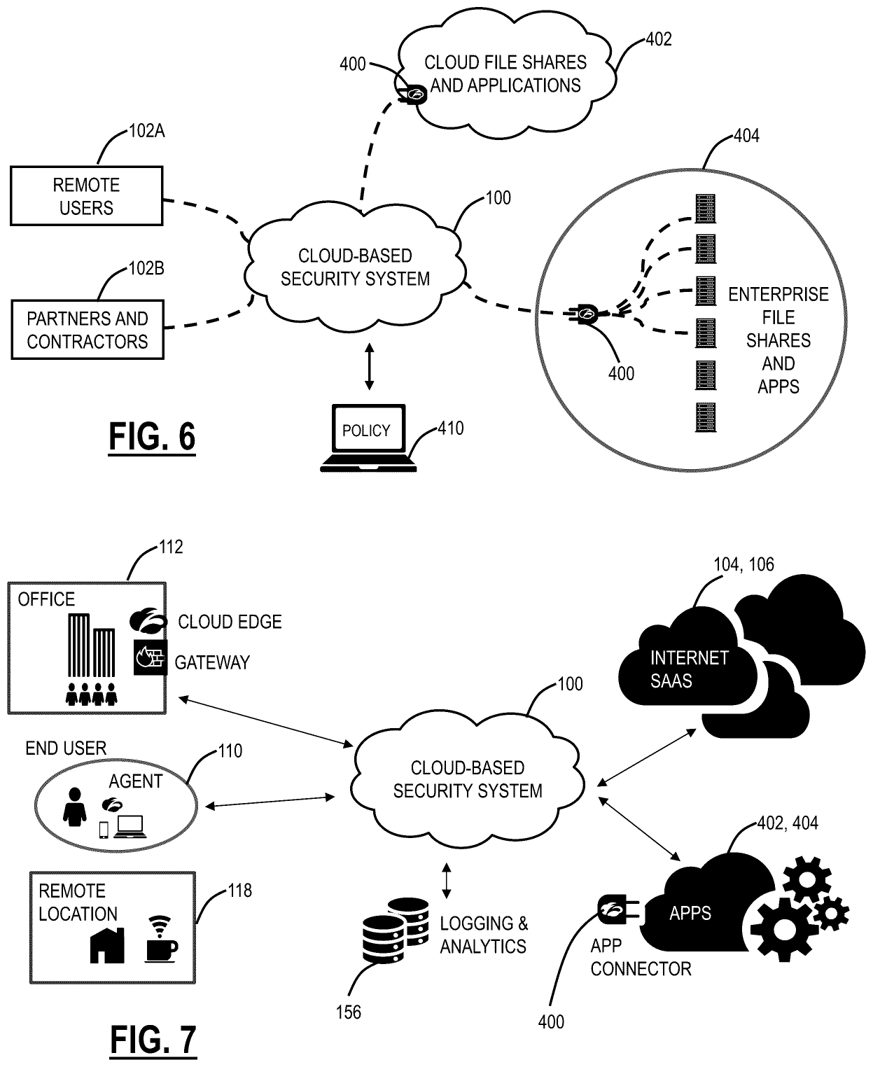

FIG. 6 is a network diagram of a Zero Trust Network Access (ZTNA) application utilizing the cloud-based system 100. For ZTNA, the cloud-based system 100 can dynamically create a connection through a secure tunnel between an endpoint (e.g., users 102A, 102B) that are remote and an on-premises connector 400 that is either located in cloud file shares and applications 402 and/or in an enterprise network 404, connected to enterprise file shares and applications. The connection between the cloud-based system 100 and on-premises connector 400 is dynamic, on-demand, and orchestrated by the cloud-based system 100. A key feature is its security at the edge—there is no need to punch any holes in the existing on-premises firewall. The connector 400 inside the enterprise (on-premises) “dials out” and connects to the cloud-based system 100 as if too were an endpoint. This on-demand dial-out capability and tunneling authenticated traffic back to the enterprise is a key differentiator for ZTNA. Also, this functionality can be implemented in part by the application 350 on the user device 300. The connector 400 can be referred to as a “service edge.”

The paradigm of virtual private access systems and methods is to give users network access to get to an application and/or file share, not to the entire network. If a user is not authorized to get the application, the user should not be able even to see that it exists, much less access it. The virtual private access systems and methods provide an approach to deliver secure access by decoupling applications 402 from the network 404, instead of providing access with a connector 400, in front of the applications 402, an application on the user device 300, a central authority 152 to push policy 410, and the cloud-based system 100 to stitch the applications 402 and the software connectors 400 together, on a per-user, per-application basis.

With the virtual private access, users can only see the specific applications 402 allowed by the policy 410. Everything else is “invisible” or “dark” to them. Because the virtual private access separates the application from the network, the physical location of the application 402 becomes irrelevant-if applications 402 are located in more than one place, the user is automatically directed to the instance that will give them the best performance. The virtual private access also dramatically reduces configuration complexity, such as policies/firewalls in the data centers. Enterprises can, for example, move applications to Amazon Web Services or Microsoft Azure, and take advantage of the elasticity of the cloud, making private, internal applications behave just like the marketing leading enterprise applications. Advantageously, there is no hardware to buy or deploy, because the virtual private access is a service offering to end-users and enterprises. FIG. 5 can include the ZPA service from Zscaler, Inc.

### Digital Experience Monitoring

FIG. 7 is a network diagram of the cloud-based system 100 in an application of digital experience monitoring. Here, the cloud-based system 100 providing security as a service as well as ZTNA, can also be used to provide real-time, continuous digital experience monitoring, as opposed to conventional approaches (synthetic probes). A key aspect of the architecture of the cloud-based system 100 is the inline monitoring. This means data is accessible in real-time for individual users from end-to-end. As described herein, digital experience monitoring can include monitoring, analyzing, and improving the digital user experience.

The cloud-based system 100 connects users 102 at the locations 110, 112, 118 to the applications 402, the Internet 104, the cloud services 106, etc. The inline, end-to-end visibility of all users enables digital experience monitoring. The cloud-based system 100 can monitor, diagnose, generate alerts, and perform remedial actions with respect to network endpoints, network components, network links, etc. The network endpoints can include servers, virtual machines, containers, storage systems, or anything with an IP address, including the Internet of Things (IoT), cloud, and wireless endpoints. With these components, these network endpoints can be monitored directly in combination with a network perspective. Thus, the cloud-based system 100 provides a unique architecture that can enable digital experience monitoring, network application monitoring, infrastructure component interactions, etc. Of note, these various monitoring aspects require no additional components—the cloud-based system 100 leverages the existing infrastructure to provide this service.

Again, digital experience monitoring includes the capture of data about how end-to-end application availability, latency, and quality appear to the end user from a network perspective. This is limited to the network traffic visibility and not within components, such as what application performance monitoring can accomplish. Networked application monitoring provides the speed and overall quality of networked application delivery to the user in support of key business activities. Infrastructure component interactions include a focus on infrastructure components as they interact via the network, as well as the network delivery of services or applications. This includes the ability to provide network path analytics.

The cloud-based system 100 can enable real-time performance and behaviors for troubleshooting in the current state of the environment, historical performance and behaviors to understand what occurred or what is trending over time, predictive behaviors by leveraging analytics technologies to distill and create actionable items from the large dataset collected across the various data sources, and the like. The cloud-based system 100 includes the ability to directly ingest any of the following data sources network device-generated health data, network device-generated traffic data, including flow-based data sources inclusive of NetFlow and IPFIX, raw network packet analysis to identify application types and performance characteristics, HTTP request metrics, etc. The cloud-based system 100 can operate at 10 gigabits (10G) Ethernet and higher at full line rate and support a rate of 100,000 or more flows per second or higher.

The applications 402 can include enterprise applications, Office 365, Salesforce, Skype, Google apps, internal applications, etc. These are critical business applications where user experience is important. The objective here is to collect various data points so that user experience can be quantified for a particular user, at a particular time, for purposes of analyzing the experience as well as improving the experience. In an embodiment, the monitored data can be from different categories, including application-related, network-related, device-related (also can be referred to as endpoint-related), protocol-related, etc. Data can be collected at the application 350 or the cloud edge to quantify user experience for specific applications, i.e., the application-related and device-related data. The cloud-based system 100 can further collect the network-related and the protocol-related data (e.g., Domain Name System (DNS) response time).

### Application-Related Data

| | |
|---|---|
| Page Load Time | Redirect count (#) |
| Page Response Time | Throughput (bps) |
| Document Object Model | Total size (bytes) |
| (DOM) Load Time | |
| Total Downloaded bytes | Page error count (#) |
| App availability (%) | Page element count by |
| | category (#) |

### Network-Related Data

| | |
|---|---|
| HTTP Request metrics | Bandwidth |
| Server response time | Jitter |
| Ping packet loss (%) | Trace Route |
| Ping round trip | DNS lookup trace |
| Packet loss (%) | GRE/IPSec tunnel monitoring |
| Latency | MTU and bandwidth measurements |

### Device-Related Data (Endpoint-Related Data)

| | |
|---|---|
| System details | Network (config) |
| Central Processing Unit (CPU) | Disk |
| Memory (RAM) | Processes |
| Network (interfaces) | Applications |

Metrics could be combined. For example, device health can be based on a combination of CPU, memory, etc. Network health could be a combination of Wi-Fi/LAN connection health, latency, etc. Application health could be a combination of response time, page loads, etc. The cloud-based system 100 can generate service health as a combination of CPU, memory, and the load time of the service while processing a user's request. The network health could be based on the number of network path(s), latency, packet loss, etc.

The lightweight connector 400 can also generate similar metrics for the applications 402. In an embodiment, the metrics can be collected while a user is accessing specific applications that user experience is desired for monitoring. In another embodiment, the metrics can be enriched by triggering synthetic measurements in the context of an inline transaction by the application 350 or cloud edge. The metrics can be tagged with metadata (user, time, app, etc.) and sent to a logging and analytics service for aggregation, analysis, and reporting. Further, network administrators can get UEX reports from the cloud-based system 100. Due to the inline nature and the fact the cloud-based system 100 is an overlay (in-between users and services/applications), the cloud-based system 100 enables the ability to capture user experience metric data continuously and to log such data historically. As such, a network administrator can have a long-term detailed view of the network and associated user experience.

### Unified Agent Application

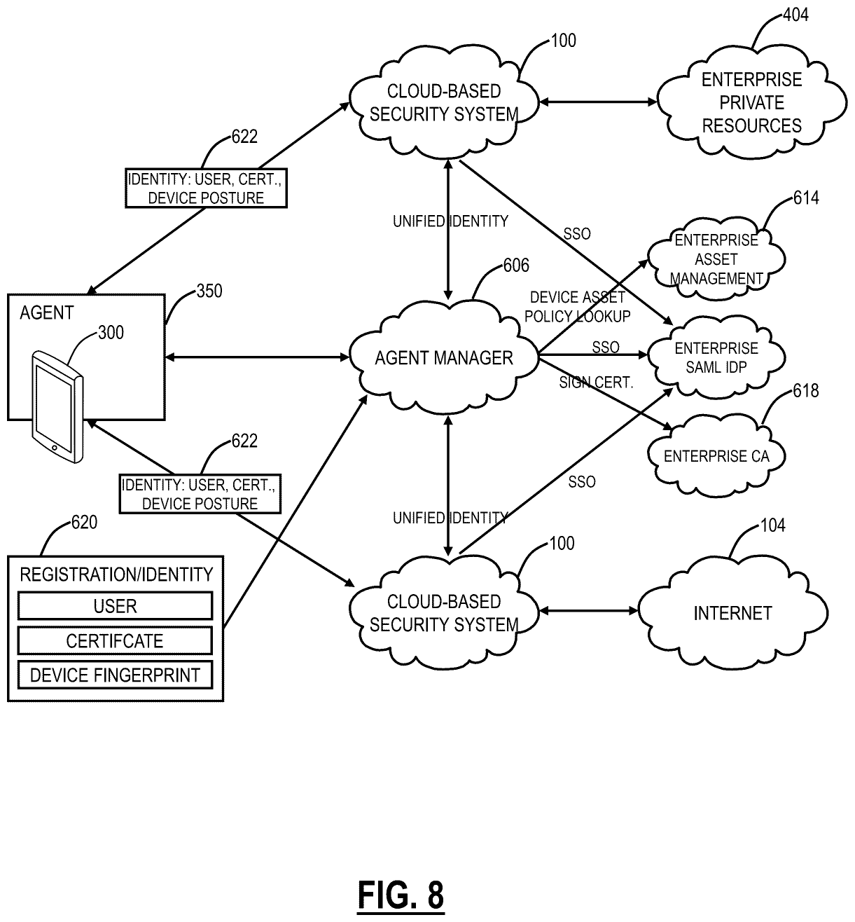

FIG. 8 is a network diagram of the use of the application 350 as a unified agent application and associated connectivity and functionality with the cloud-based system 100, i.e., a “client connector.” Again, the unified agent application 350 is executed on a user device 300. The unified agent application 350 dynamically learns all available services, adapts to changing network environments, and provides a seamless and secure network resource access to Internet and darknet hosted applications. This is achieved through dynamic evaluation of network conditions, enrollment to individual services, learning individual service protocols, creating a link-local network on the user device 300, and establishing multiple secure tunnels to cloud services over this local network.

The unified agent application 350 is communicatively coupled to an agent manager cloud 606, as well as the cloud-based system 100. The unified agent application 350 enables communication to enterprise private resources on the enterprise network 404 via the cloud-based system 100 and to the Internet 104 via the cloud-based system 100. The agent manager cloud 606 can communicate with enterprise asset management 614, an enterprise Security Assertion Markup Language (SAML) Identity Provider (IDP) 616, and an enterprise Certificate Authority (CA) 618. The user device 300 and the unified agent application 350 can perform a registration/identity 620 process through the agent manager cloud 606 where the user identity, the user's certificates, and a device fingerprint can uniquely identify the user device 300. Once registered, the unified agent application 350 has an identity 622, which can include the user, certificates, device posture, etc. and which is shared with the cloud-based system 100.

The unified agent application 350 operates on a client-server model where an IT admin enables appropriate services for end users at a Cloud Administration Server (CAS), which can be part of the agent manager cloud 606, namely the enterprise asset management 614. Every client can make a unicast request to the agent manager cloud 606 (e.g., CAS) to discover all enabled services. On acknowledging the response, the client issues a request to authenticate to each service's cloud Identity Providers, the enterprise SAML IDP 616. Authentication can be multi-factor depending upon the nature of the service. On successful authentication, server contacts Mobile Device Management (MDM) or Inventory management provider to define access control rights for the user device 300. Post authorization, the user device 300 is successfully enrolled in the agent manager cloud 606, which tracks and monitors all behavior of the user device 300.

Post-enrollment, the user device 300 creates a link local network with a specific IP configuration, opens a virtual network interface to read and write packets to create secure tunnels to available services through the cloud-based system 100. On network changes, the user device 300 dynamically evaluates reachability to pre-configured domains and depending upon the result, it appropriately transitions all network tunnels, thus providing a seamless experience to the end user. Further, the user device 300 also intelligently learns the conditions which are appropriate for setting up network tunnels to cloud services depending upon several network heuristics such as reachability to a particular cloud service.

### Unified Agent Application—Functionality

Generally, the unified agent application 350 supports two broad functional categories—1) dynamic service discovery and access controls and 2) service availability. The dynamic service discovery and access controls include service configuration by the administrator, service discovery by the user device 300, service acknowledgment and authentication, service authorization and enrollment, and the like. For service configuration by the administrator, the IT admin can provide cloud service details at a centralized knowledge server, such as part of the agent manager cloud 606, the enterprise asset management 614, etc. The cloud service details include the service type (e.g., Internet/intranet), network protocol, identity provider, server address, port, and access controls, etc.

For service discovery by the user device 300, the user device 300 can issue a network request to a known Cloud Administrative Server (CAS) in the agent manager cloud 606 to discover all enabled services for a user. If a specific cloud server is not known a priori, the user device 300 can broadcast the request to multiple clouds, e.g., through the agent manager cloud 606 communicating to the enterprise asset management 614, the enterprise SAML IDP 616, and the enterprise CA 618.

For the service acknowledgment and authentication, the user device 300 acknowledges the response of service discovery and initiates the authentication flow. The user device 300 learns the authentication protocol through the service discovery configuration and performs authentication of a configured nature at the enterprise SAML IDP 616. For the service authorization and enrollment, post successful authentication, the CAS, authorizes the user device 300, and fetches the access control information by contacting an MDM/Inventory Solutions Provider. Depending upon the user context and the nature of access, the CAS enrolls the user device 300 into several cloud services and informs the cloud services that the user has been enrolled for access.

The service availability includes link local network setup, a traffic interceptor, and dynamic traffic forwarding tunnels to authorized services. The link-local network setup, post-enrollment, has the user device 300 create a local network on the user device 300 itself to manage various networking functionalities. For the traffic interceptor, the user device 300 intercepts and evaluates all Internet traffic. Allowed traffic is tunneled to the cloud services such as in the cloud-based system 100, whereas the rest of the traffic is denied as per enterprise policies. For the dynamic traffic forwarding tunnels to authorized services, depending upon the evaluation, the user device 300 splits the traffic into the different tunnel to individual cloud services such as in the cloud-based system 100.

The unified agent application 350 is a single application that provides secure connectivity to the Internet 104 and darknet hosted applications, such as the enterprise private resources in the enterprise network 404. The unified agent application 350 communicates securely to the agent manager cloud 606, which is controlled by an IT admin. The unified agent application 350 learns available services and authenticates with each service. Post proper enrollment, the unified agent application 350 securely connects to cloud services by means of network tunnels.

### Unified Agent Application—Workflow

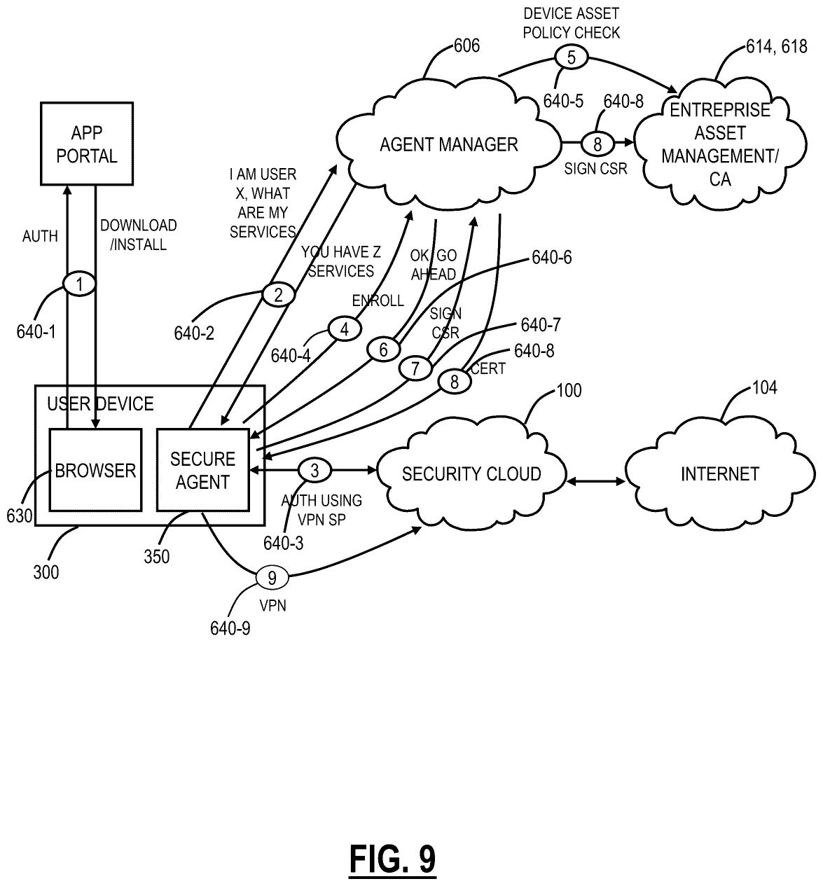

FIG. 9 is a network diagram of the example workflow of the unified agent application 350. The user device 300 again executes the unified agent application 350, as well as a browser 630 (or some other application requesting network services). First, the user device 300 includes authentication through an application portal 632 and download/install of the unified agent application 350 therefrom (step 640-1). Note, the application portal 632 can be a website, Apple's app store, Google Play, Windows Store, etc. Once installed, the unified agent application 350 communicates to the agent manager cloud 606 communicating identity and asking for available services (“I am User X, what are my services?”) and the agent manager cloud 606 responds with the available services (“You have Z services”) (step 640-2).

Next, the unified agent application 350 includes authentication using a VPN Service Provider (SP) with the cloud-based system 100 (step 640-3). The unified agent application 350 next enrolls the user device 300 through the agent manager cloud 606 (step 640-4). The agent manager cloud 606 performs a device asset policy check with the enterprise asset management 614 (step 640-5). The agent manager cloud 606, upon the successful check, provides the unified agent application 350 an affirmative response (step 640-6). The unified agent application 350 sends a Certificate Signing Request (CSR) to the agent manager cloud 606 (step 640-7), and the agent manager cloud 606 sends the CSR request to the enterprise CA, and the certificate is returned to the unified agent application 350 (step 640-8). Finally, the unified agent application 350 enables VPN connectivity to the cloud-based system 100 (step 640-9).

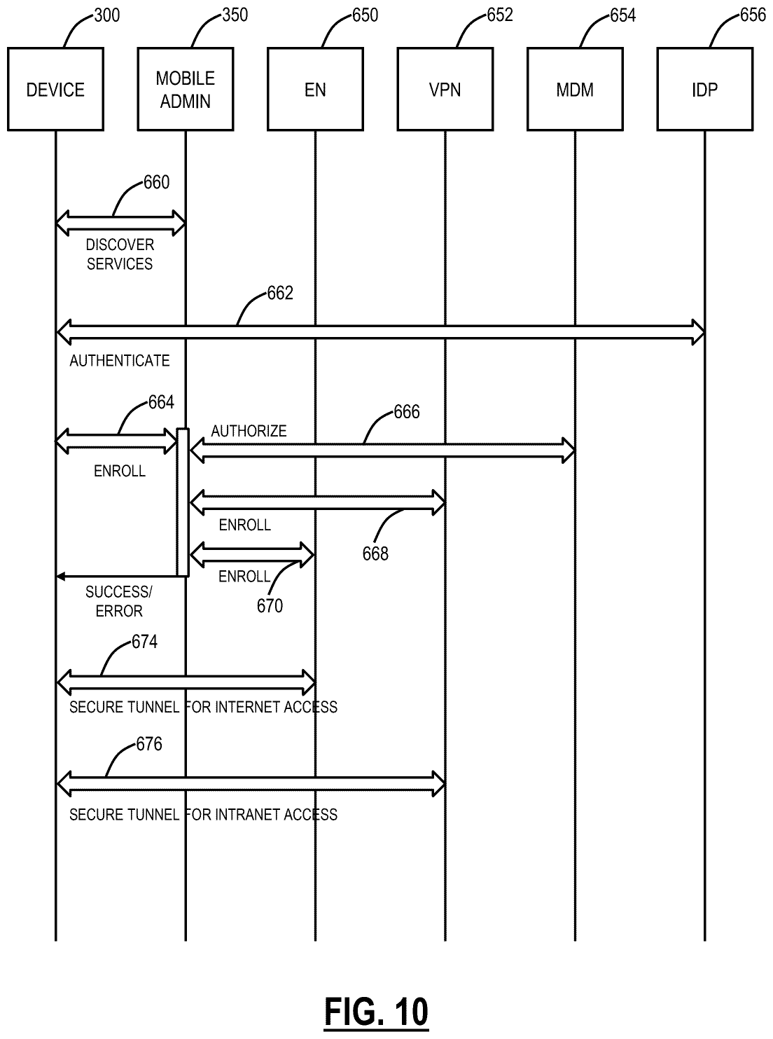

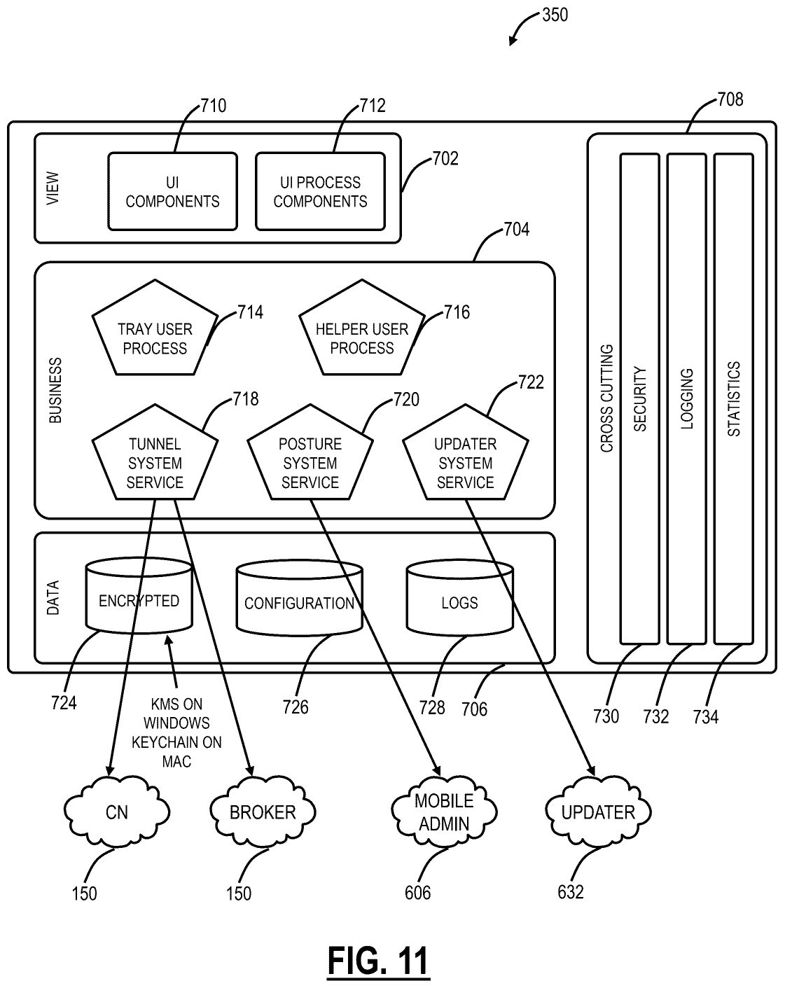

FIG. 10 is a flow diagram of an event sequence associated with the unified agent application 350. The event sequence is shown between the user device 300 executing the unified agent application 350, a mobile admin function 650 such as implemented through the agent manager cloud 606, an enforcement node 150, a VPN node 652 such as through the cloud-based system 100, an MDM function 654 such as through the enterprise asset management 614, and an IDP function 656 such as through the enterprise SAML IDP 616. The user device 300 discovers services with the mobile admin function 650 (step 660), and the user device 300 is authenticated by the IDP function 656 (step 662). The user device 300 enrolls in discovered services through the mobile admin function 650 (step 664).

The mobile admin function 650 is configured to authorize the services with the MDM function 654 (step 666), enroll in the services through the VPN node 652 (step 668), and the enforcement nodes 150 (step 670). A success/error is provided by the mobile admin function 650 to the user device 300. Subsequently, the user device 300, through the unified agent application 350, accesses the services such as a secure tunnel for internet access through the enforcement nodes 150 (step 674) or a secure tunnel for intranet access through the VPN node 652 (step 676).

### Unified Agent Application—Architecture

FIG. 11 is a logical diagram of the functional components of the unified agent application 350. The unified agent application 350 is configured to operate on the mobile user device 300. The cloud-based system 100 can provide Internet security as well as cloud-based remote access to enterprise internal resources through a VPN. These cloud services are designed and well suited for road warriors. Road warriors are the users who are accessing the Internet 104 and enterprise internal services from outside the corporate physical network perimeter. These are the users 102 who are accessing the Internet 104 and Enterprise resources from home, airports, coffee shops, and other external unsecured hotspots.

The unified agent application 350 provides authenticated and encrypted tunnels from road warrior devices 300 and, in some use cases, it even needs to be enforceable so that end users cannot disable the unified agent application 350. The VPN, which is the remote access service, also needs authenticated and encrypted tunnel from road warrior user devices 300. Both of these solutions also need to provide feedback to the end user in the event that access was blocked due to security or compliance reasons. The following describes the architecture and design of the unified agent application 350, including an endpoint client architecture, backend changes, auto-update, and integration with the cloud-based system 100.

The unified agent application 350 includes logical components including view components 702, business processes and services 704, data 706, and cross-cutting functions 708. The view components 702 include User Interface (UI) components 710 and UI process components 712. The business processes and services 704 include a tray user process 714, a helper user process 716, a tunnel system service 718, a posture system service 720, and an updater system service 722. The data 706 includes encrypted data 724, configuration data 726, and logs 728. The cross-cutting functions 708 are across the view components 702, the business processes and services 704, and the data 706 and include security 730, logging 732, and statistics 734.

The unified agent application 350 has a useful goal of simplified provisioning of the proxy (for security through the cloud-based system 100 to the Internet 104) and the VPN (for access through the cloud-based system 100 to the enterprise private resources in the enterprise network 404). That is, the unified agent application 350 allows the use of the cloud-based system 100 as a proxy for Internet-bound communications. The unified agent application 350 further allows the use of the cloud-based system 100 as a tunnel for Intranet-bound communications to the enterprise private resources. With the unified agent application 350 setting up a local network at the user device 300, the unified agent application 350 can manage communications between the Internet and the intranet, i.e., two of the main categories of cloud services-proxy to the Internet and tunnel to the intranet. The unified agent application 350 further has objectives of simplified user enrollment in the proxy and tunnels.

In an embodiment, the unified agent application 350 is a native application. The common functionality is abstracted out and made into common libraries based on C or C++ so that it can be reused across different platforms (e.g., IOS, Android, etc.). Example functionality: Traffic forwarding tunnels, local proxy, authentication backend, logging, statistics, etc. The UI components 710 and UI process components 712 can be platform dependent. Also, the unified agent application 350 is designed and implementable such that other third-party VPN applications, if configured by the enterprise, can be used concurrently.

The app portal 632 enables the installation of the unified agent application 350 on the user device 300. For example, an admin may be able to push and install the unified agent application 350 to the user device 300 using remote-push mechanisms like GPO, MDMs, etc. Additionally, the user can download the unified agent application 350 if they have access to the installation file and install it on their own. The unified agent application 350 supports automatic updates without impacting the user's Internet experience. If a problem is encountered, then it should roll back to the previously successful state or fail open. The unified agent application 350 can have a security check to ensure that it is not tampered and updated from the right source with a hash match with a source hash when upgrading.

The user can log into the unified agent application 350. Once the user sends their User ID through the unified agent application 350 to the agent manager cloud 606, the cloud-based system 100, and/or the app portal 632, the app portal 632 can determine the company's authentication mechanism, such as through a lookup in the enterprise asset management 614, and validate password through the enterprise CA 618.

Through the unified agent application 350, a user can be authenticated to the proxy or the VPN through the cloud-based system 100. For authentication of the user to the proxy, using SAML, the user can log into the unified agent application 350 by using their user ID and transparent SAML authentication thereafter, including SAML certificate. The app portal 632 shall determine that an organization is using SAML for authentication through the enterprise CA 618 and redirect to the enterprise SAML IDP 616 to get SAML assertion and use it to authenticate the user.

For authentication of the user to the tunnel, using SAML, the user can log into the unified agent application 350 by just using their user ID and based on the user ID, the unified agent application 350 shall redirect the user for authentication to enterprise SAML IDP 616 and SAML assertion shall be sent. The VPN service shall validate SAML assertion; if the assertion is valid, then the unified agent application 350 shall collect hardware parameters like device serial number, model number, etc. and create CSR. The CSR shall be signed by the enterprise CA 618, and the certificate shall be pushed to the unified agent application 350. The unified agent application 350 shall install the certificate to KMS/keychain and save assertion.

After the user has been successfully authenticated, the user shall be enrolled in the proxy service, and the user's traffic forwarding profile shall be downloaded from unified agent application 350, including Secure Sockets Layer (SSL) certificates and exceptions. The unified agent application 350 shall indicate that the user is connected to cloud-based system 100, and app statistics shall be populated.

After the user has successfully authenticated (including transparent authentication), the user shall be enrolled with a VPN service, and the VPN broker info shall be downloaded by the unified agent application 350, and the VPN tunnel shall be established. The unified agent application 350 can support captive portal detection to fail open when users are behind a captive portal to allow connection to a captive portal.

The unified agent application 350 can forward internal enterprise traffic from the user device 300 to the VPN. The unified agent application 350 can recognize when a user goes to an internal app that is provisioned with the VPN service. The unified agent application 350 shall auto-enable a tunnel to the VPN service when the user tries connecting to an internal app. The proxy service can always be enforced, and the user is not able to remove it by switching off tunnel or removing the unified agent application 350. Without the proxy solution enforced, the user is not able to access the Internet and would be prompted to restart the web security service, via the unified agent application 350.

The VPN is an on-demand service, unlike the proxy service that shall be enforceable by default so that the user can enable/disable the VPN at will without any password requirements. Once the user logs into the VPN service using a ‘Connect,’ the same button shall be labeled ‘Disconnect,’ and the user shall be able to disconnect the VPN service with a single click. Every time user disconnects with VPN service. The VPN service can be auto-disabled if the user puts their system to sleep mode or there is inactivity (no packets exchanged) after x minutes (x shall be configurable in the VPN settings).

The admin can turn off the proxy service with a single client from an admin UI for a user, all users, or some subset of users. This does not remove the unified agent application 350 from the user device 300. A user may be able to disable the proxy service, provided they have the authority and credentials. The unified agent application 350 can provide service-related notifications to the user. For example, the unified agent application 350 can provide notifications such as push alerts or the like as well as contain a notification area for a single place to show all notifications that are generated by the proxy service and the VPN service. This shall also include app notifications, including configuration updates, agent updates, etc. The user shall be able to clear notifications as well as filter notifications from this screen. This shall include a filter for VPN/Proxy, blocked, cautioned, quarantine actions.

### Unified Agent Application—User Workflow

Again, the unified agent application 350 is executed on the user device 300. For authentication, the user enters a User ID in the unified agent application 350, such as userid@domain. Subsequently, the unified agent application 350 is configured to discover the services enabled-proxy service and VPN services based on userid@domain. The user authenticates with the presented services, i.e., proxy service, VPN services, and combinations thereof. The unified agent application 350 is auto-provisioned for the authenticated service by downloading the service-specific configuration. The unified agent application 350 performs the following during VPN enrollment-get the User/Device certificate signed by an Enterprise Intermediate Certificate. This Intermediate Certificate will be the same, which will be used for signing Assistants. The unified agent application 350 also will pin hardware signatures/fingerprints to the certificate and user, e.g., Storage Serial ID (Hard Drive Serial ID), CPU ID, Mother Board Serial ID, BIOS serial number, etc.

### Unified Agent Application—Authentication and Enrollment Protocol

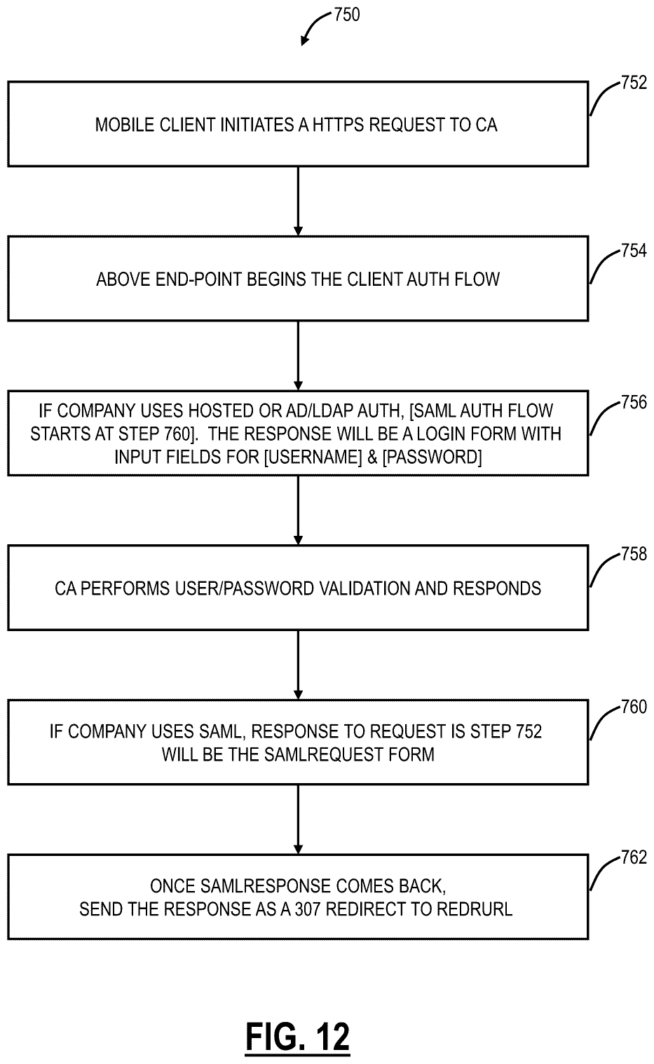

FIG. 12 is a flowchart of a proxy authentication process 750 to the cloud-based system 100. For authentication in the proxy service, conventionally, devices 300 can use proxy authentication to register to the cloud-based system 100. This is not truly reliable as it depends on location/location-authentication policy/VPN and other such factors to work correctly. To simplify this flow, the following new flow can be used with the unified agent application 350 for the process 750. First, the mobile client user device 300 initiates an HTTPS request to a CA (e.g., the enterprise CA 618) (step 752). For example, this can be as follows:
login.zscaler.net/clstart?version=1&_domain=nestle.com&redrurl=<url-encoded-url-with-schema>
If the domain is invalid or if the redrurl is missing, CA will reset the connection.

The above endpoint begins the client auth flow (step 754). The provided domain is the company that requires the auth. The CA looks up the domain to find the company and their auth mechanism. If the company uses hosted or Active Directory (AD)/Lightweight Directory Access Protocol (LDAP) authentication [SAML auth flow starts at step 760], the response will be a login form with input fields for [username] & [password] (step 756).
The form is submitted via POST to the CA at a below endpoint:
https://login.zscaler.net/clicred. The HTTP content may look like below
POST/clicred
Host: login.zscaler.net
Content-Length: xyzusername=xyz@nestle.com&password=123456&redrurl=<url-encoded-posturl-with-schema>

Next, the CA performs user/password validation and responds with a message (step 758). If the company uses SAML, the response to the request in step 752 will be the SAMLRequest form. The SAMLRequest form will auto-submit to the IDP. Once auth completes, the CA gets control back with the identity of the user. Once SAMLResponse comes back, send the response as a 307 redirect to redrurl (step 762) with a below format
Location: zsa://auth [?token=encrypted-cookie& . . . ] to be appended.
307 query params

$$\begin{matrix}token = ( on success ) \\ ecode = ( on error ) \\ emsg = ( on error )\end{matrix}$$

On error, send the same redrurl with below format

$$zsa : // auth ? ecode = < code > \& emsg = < message >$$

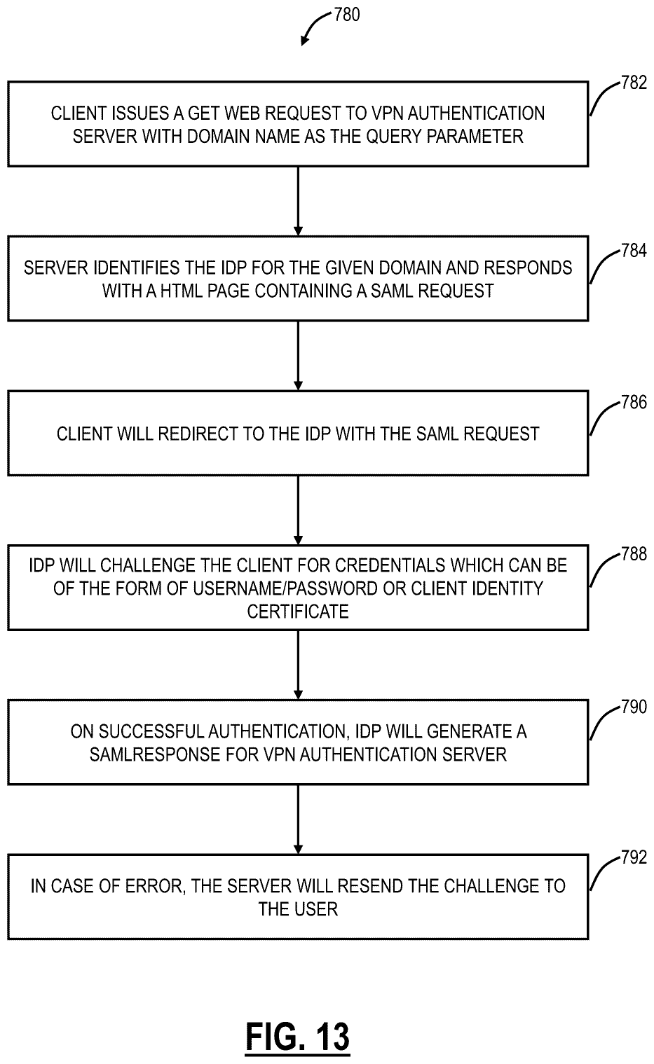

FIG. 13 is a flowchart of a VPN authentication process 780 to the cloud-based system 100. The client (user device 300) issues a GET web request to the VPN authentication server with the domain name as the query parameter (step 782), such as:
GET//<auth-server>?domain=mockcompany.com

The server identifies the IDP for the given domain and responds with a Hypertext Markup Language (HTML) page containing a SAML Request (step 784). The client will redirect to the IDP with the SAML Request (step 786). The IDP will challenge the client for credentials, which can be of the form of a username/password or client identity certificate (step 788). On successful authentication, IDP will generate a SAMLResponse for the VPN authentication server (step 790). The client will record the SAMLAssertion for future tunnel negotiation. In the case of error, the server will resend the challenge to the user (step 792).

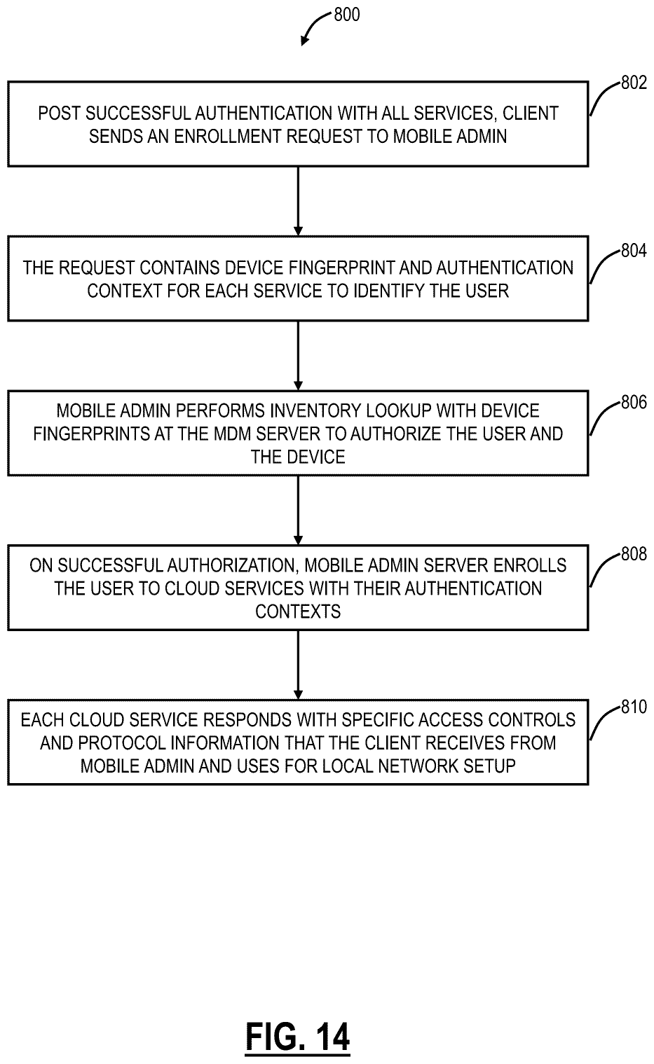

FIG. 14 is a flowchart of a device enrollment process 800 for the client user device 300 and the unified agent application 350. Post successful authentication with all services, in this case, the proxy services, and the VPN services, the client sends an enrollment request to mobile admin (Cloud Administrative Server CAS) (step 802). The request contains a device fingerprint and an authentication context for each service to identify the user (step 804). For example, the cloud-based system 100 can use cookies, and the VPN can use SAMLAssertion for the authentication context. The mobile admin (agent manager cloud 606) performs inventory lookup with device fingerprints at the MDM server to authorize the user and the user device 300 (step 806). On successful authorization, the mobile admin server enrolls the user to cloud services with their authentication contexts (step 808). Each cloud service responds with specific access controls and protocol information that the client receives from mobile admin and uses for local network setup (step 810).

### Unified Agent Application—Traffic Interception and Splitting

Again, to protect Internet-bound traffic and simultaneously access enterprise-specific Intranet traffic, the user device 300 needs to connect through multiple applications. Again, it is not straightforward for users to configure these applications in different networks, and different VPN and proxy solutions arise compatibility issues when operating simultaneously. The unified agent application 350 is designed to solve all these issues. The unified agent application 350 handles both proxy (Internet-bound) traffic, and Enterprise Intranet bound traffic. The unified agent application 350 provides secure access to Organizational internal resources when the user is outside of the enterprise network. For Internet-bound traffic, it will forward traffic to the enforcement node 150, and for intranet bound traffic, it will forward traffic to a VPN (Broker) or direct if the user is inside the organization network.

The unified agent application 350 is configured to intercept all traffic, specifically to intercept all Transmission Control Protocol (TCP) traffic and DNS traffic before it goes out through the external network interface in the user device 300. The unified agent application 350 can intercept other types of traffic as well, such as the User Datagram Protocol (UDP). The unified agent application 350 is configured to split traffic at the user device 300, i.e., based on a local network configured at the user device 300. Split traffic based upon port, protocol, and destination IP. The unified agent application 350 is configured to send VPN traffic direct for trusted networks (organization's internal network). The unified agent application 350 can also coexist with other VPN clients, i.e., it does not intercept the traffic targeted for those interfaces by specific routes.

Thus, the unified agent application 350 is configured to intercept all traffic at the IP layer for the device 300 or other VPN client's default route. Then, the unified agent application 350 is configured to split traffic. Based upon port, protocol, and destination IP as configured by the IT administrator

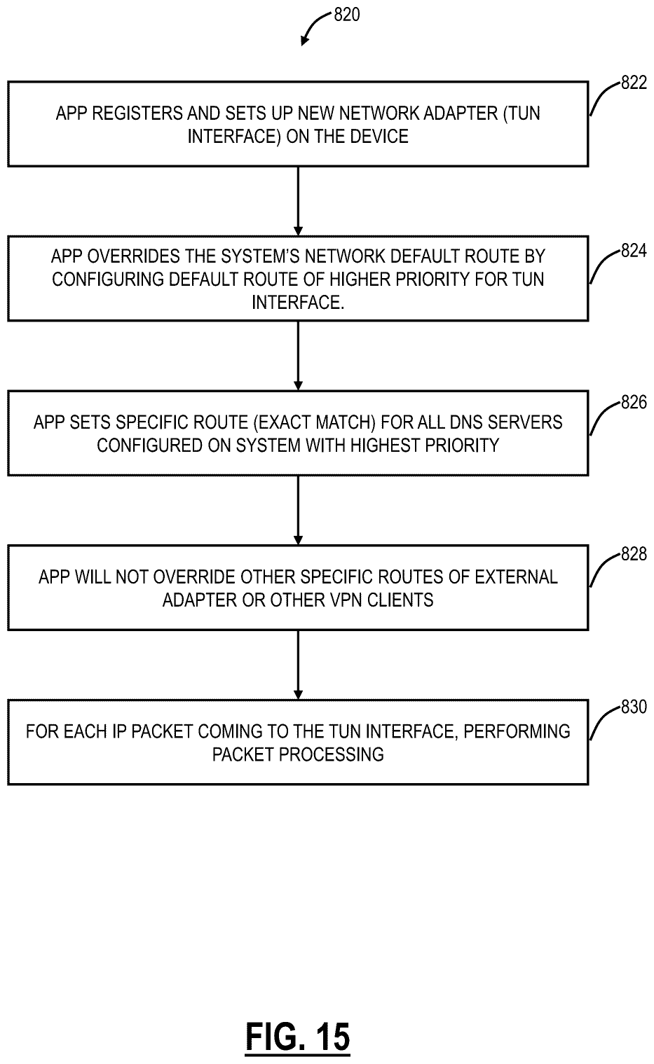

FIG. 15 is a flowchart of a traffic interception process 820 implemented through the unified agent application 350. The unified agent application 350 registers and sets up a new Network Adapter (TUN interface) on the device (step 822). The unified agent application 350 overrides the device's network default route by configuring the default route of higher priority for the TUN interface (step 824). The unified agent application 350 sets a specific route (exact match) for all DNS servers configured on the user device 300 with the highest priority (step 826). The unified agent application 350 will not override other specific routes of an external adapter or other VPN clients (step 828).

For each IP packet coming to the TUN interface, packet processing is performed (step 830). The application does a <port, protocol, destination-IP> lookup on every IP packet and sends it on one of the dedicated tunnels based upon configured rules of packet transport.

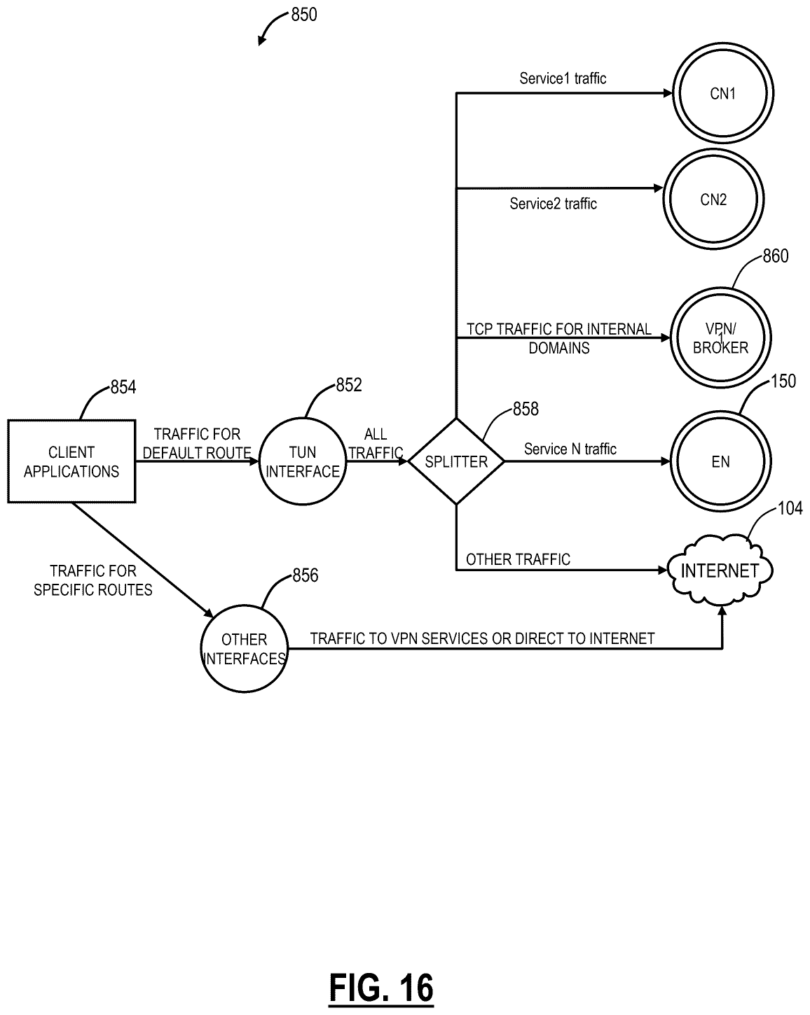

FIG. 16 is a flow diagram of traffic interception and splitting 850 using the unified agent application 350. Again, the unified agent application 350 creates and operates a tunnel (TUN) interface 852 on the user device 300. The user device 300 includes one or more client applications 854, which can be any program or service executable on the user device 300, which requires access to the network interface on the user device 300. Traffic for the default route from the client applications 854 is sent to the TUN interface 852, but traffic for specific routes can be sent to other interfaces 856, separate from the TUN interface, for direct connectivity to the Internet 504, such as via VPN services or direct.

The TUN interface 852 splits 858 all traffic. TCP traffic for internal domains is sent to a VPN/broker server 860, TCP port 80/443 traffic is sent to the cloud-based system 100 for a proxy such as to the enforcement node 150. Finally, other traffic can be sent directly to the Internet 504. In this manner, the TUN interface 852 operates a local network at the user device 300.

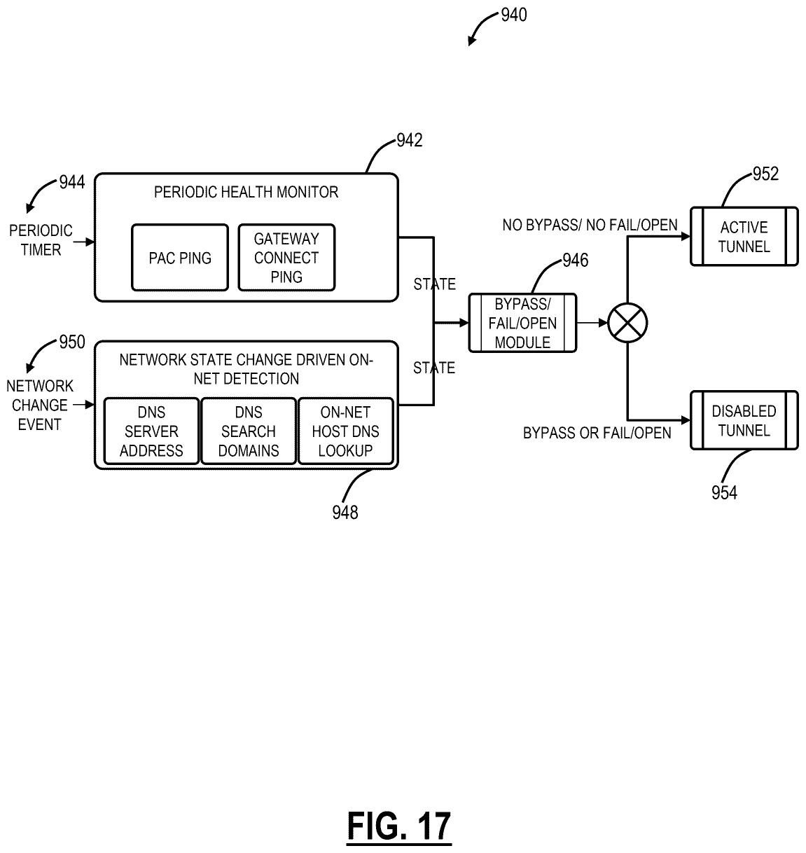

FIG. 17 is a flow diagram of tunnel forwarding rules 940 by the unified agent application 350. A periodic health monitor function 942 operates, based on a periodic timer 944, to check a PAC ping and a gateway connect ping to provide a state to a bypass fail/open module 946. A network state change function 948 is configured to detect a network change event 950 such as DNS server address, DNS search domains, on-net host DNS lookups, etc., and to provide a state to the bypass fail/open module 946. The bypass fail/open module 946 creates an active tunnel 952 or disabled tunnel 954 based on the states.

### Service Driven Split Tunneling

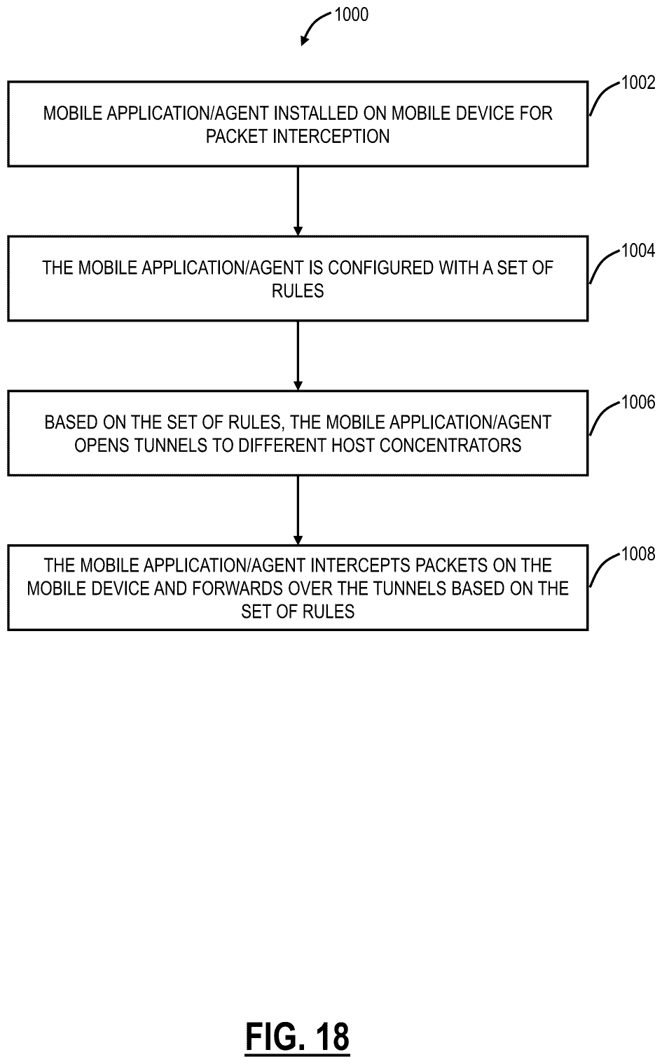

FIG. 18 is a flowchart of a service driven split tunneling process 1000. The service driven split tunneling process 1000 provides better scalability, security, and segmentation of traffic in mobile and cloud environments. The service driven split tunneling process 1000 can include the traffic interception and splitting 850 using the unified agent application 350. Again, as illustrated in FIG. 18, the unified agent application 350 creates and operates a tunnel (TUN) interface 852 on the mobile user device 300. The mobile user device 300 includes one or more client applications 854, which can be any program or service executable on the user device 300, which requires access to the network interface on the user device 300. Traffic for the default route from the client applications 854 is sent to the TUN interface 852, but traffic for specific routes can be sent to other interfaces 856, separate from the TUN interface, for direct connectivity to the Internet 504, such as via VPN services or direct.

The service driven split tunneling process 1000 includes a mobile application/agent which is installed on a mobile device for packet interception (step 1002). For example, the mobile application/agent can be the unified agent application 350 on the mobile user device 300. The mobile application/agent can inject a default route on the mobile device pointing to its own interface to get all Layer 2 or Layer 3 packets.

The mobile application/agent is configured with a set of rules (step 1004). The set of rules can be learned at runtime (as the mobile application/agent operates, configured at application launch, configured during application operation, and a combination thereof. For example, the set of rules can be configured by IT administrators for specific users, groups, departments, etc. and sent to the mobile application/agent. Further, the set of rules can be learned based on the operation of the mobile application/agent.

The set of rules can be an array of tuples of included and excluded traffic. For example, the array of tuples can include the following format
<exclude, destination_port, protocol, destination_IP address_subnet>
<include, destination_port, protocol, destination_IP address_subnet, transport_type>

For example, a set of rules can include
<include, 443, TCP, 17.0.0.0/8, <TCP, gateway.zscaler.net:80
   This rule would tunnel all TCP port 443 traffic destined to 17.0.0.0/8 subnet over a TCP transport on port 80 to host.com. Another rule can include
<exclude, 53, UDP, *>
   This rule does not tunnel any UDP port 53 (DNS) traffic, but rather sends it direct.

Based on the set of rules, the mobile application/agent opens tunnels to different host concentrators (step 1006). As described herein, the host concentrators can be the enforcement nodes 150, etc. The tunnel may or may not be authenticated depending upon the requirements. For the traffic that needs to go direct, the mobile application/agent proxies the connections locally through a RAW Socket or via a custom TCP/IP Stack embedded within the application itself.

The mobile application/agent intercepts packets on the user device and forwards over the tunnels based on the set of rules (step 1008). Through this granular splitting of network traffic, IT administrators will have better control of the network traffic in terms of security and scalability. For instance, an IT admin can now control that only special traffic such as Session Initiation Protocol (SIP) should go outside the tunnel, and rest should go to some security gateway or vice versa. Any number of complex rules is hence possible.

End users will also have significant performance benefits over traditional SSL/IPSec VPNs where traffic of different needs compete with each other. The service driven split tunneling process 1000 allows function-driven security and on-demand scalability for different services. So, File Transfer Protocol (FTP) traffic goes to a secure FTP proxy, Web traffic (TCP, port 80 traffic) goes to a Web proxy, HTTPS (TCP, port 443) goes to an SSL acceleration proxy, SIP traffic goes to SIP traffic processing concentrator and so on.

### Hybrid Architecture for Security Processing

Again, the present disclosure relates to mobile devices, which are one subset of the user device 300, referred to herein as a mobile device 300. The present disclosure relates to systems and methods for enforcing security policies on mobile devices 300 in a hybrid architecture. Here, the hybrid architecture means security processing occurs both via the application 350 and the cloud-based system 100 in a unified and coordinated manner. The hybrid architecture utilizes the application 350 first to generate a local decision about whether to BLOCK/ALLOW connections based on a local map. If a connection is not in the local map, the application 350 forwards a request to the cloud-based system 100 to generate a decision. In this manner, the hybrid architecture decreased bandwidth consumption between the mobile device 300 and the cloud-based system 100 by utilizing the previous BLOCK information. The hybrid architecture decreases processor utilization on the mobile device 300 by relying on a cloud service through the cloud-based system 100 for calculating request signatures, detecting malware, detecting privacy information leakage, etc. That is, the application 350 makes simple decisions-ALLOW or BLOCK, and the cloud-based system 100 does advanced processing where needed, sandbox, advanced threat detection, signature-based detection, DLP dictionary analysis, etc.

This approach also decreases the average latency, specifically for blocked requests. A user 102 gets an immediate block as opposed to a delay based on an exchange with the cloud service. Finally, this hybrid architecture approach increases the coverage of security policies/signature-based checks on mobile devices 300, because the cloud based system 100 has significant processing capability relative to the mobile device 300. Here, the application 350 is coordinating with the cloud service. The actual policies are configured in a cloud portal of the cloud-based system 100 and immediately promulgated to corresponding mobile devices 300. The application 350 serves as a gatekeeper to process simple requests, namely BLOCK/ALLOW connections, based on entries in a local map. The cloud-based system 100 processes complex requests, where entries are not in the local map or where other security policies require, such as where data requires DLP analysis, etc. Again, mobile devices 300 have limited battery, storage, processing capabilities. The application 350 is lightweight and operates considering these limitations. The local map can be referred to as a cache of security policies.

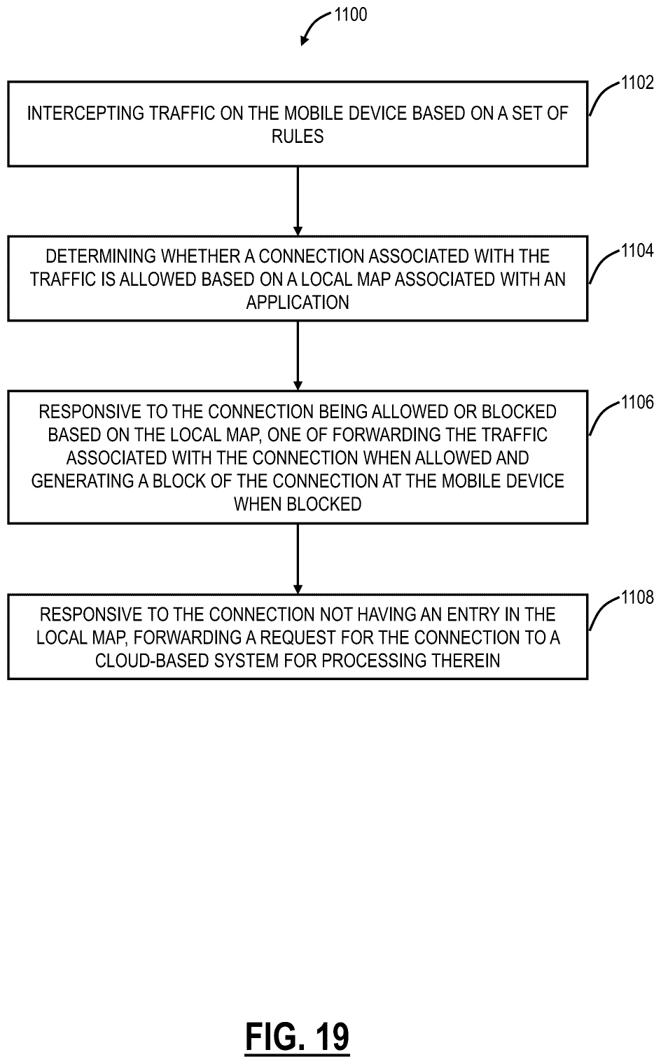

FIG. 19 is a flowchart of a process 1100 for security processing in a hybrid architecture. The process 1100 is described with reference to steps at a mobile device 300, and those skilled in the art will recognize functions are also performed in the cloud-based system 100. The process 1100 contemplates implementation as a method, via the mobile device 300, and as computer-executable instructions stored in a non-transitory computer-readable medium.

The process 1100 includes intercepting traffic on the mobile device 300 based on a set of rules (step 1102); determining whether a connection associated with the traffic is allowed based on a local map associated with an application 350 (step 1104); responsive to the connection being allowed or blocked based on the local map, one of forwarding the traffic associated with the connection when allowed and generating a block of the connection at the mobile device 300 when blocked (step 1106); and, responsive to the connection not having an entry in the local map, forwarding a request for the connection to a cloud-based system 100 for processing therein (step 1108). The cloud-based system 100 is configured to allow or block the connection based on the connection not having an entry in the local map.

There can be multiple different local maps, such as a firewall map, a domain map, and an HTTP request map. The firewall map can be the first map to consult for every connection. It has rules based on destination IP address, protocol, and port. The domain map, after the firewall map, can be consulted for HTTP and HTTPS connections. For HTTP, the application 350 can use the domain in the HTTP host header, and for HTTPS, the application 350 can use Server Name Indication (SNI). After the domain map, the HTTP domain map is consulted for HTTP requests, this map will have different set of rule categories such as: a) HTTP request type: Match HTTP domain (optional) and request type like GET/POST/HEAD, etc., b) HTTP header: Match HTTP request header key: value (optional) pairs and domain (optional), c) HTTP Version: Match Http version and domain (optional), d) Whole HTTP payload: Match http request payload SHA256 hash by excluding specific request headers.

The process 1100 can further include receiving an update from the cloud-based system 100 based on the forwarding the request to the cloud-based system 100; and updating the local map based on the update. Here, the application 350 is configured to cache previous decisions that were made by the cloud-based system 100. The process 1100 can further include receiving periodic updates from the cloud-based system 100; and updating the local map based on the periodic updates. Here, the periodic updates can be based on new security policies for a tenant of the user, detections of connections as malware or other malicious content for blocking, etc. The periodic updates can be based on monitoring in the cloud-based system and on policy of a tenant associated with a user of the mobile device.

The process 1100 can also include timing out entries in the local map and removing timed out entries. Here, the local map can have entries purged over time. This is not an issue as the fallback for any connection not found in the local map is processing in the cloud-based system 100. Thus, the local map does not need to have every possible connection entered in the local map; only ones that are used regularly. Each object within the map can have their own timeout determined based on the nature of block, e.g., for a firewall block, it can be more, and, for HTTP request payload block, it could be less.

In an embodiment, the traffic includes Hypertext Transfer Protocol (HTTP) and HTTP Secure (HTTPS) requests. The application 350 can intercept the HTTP/HTTPS requests on the mobile device 300 by means of route based rules. The routes added by the application 350 redirect all the traffic to itself via a virtual tun/tap adapter. For each incoming HTTP/HTTPS request, the application 350 consults the local map indicating if the connection needs to be blocked. In the case of BLOCK, it generates a local BLOCK response and sends it to the client application that generated the traffic. If the entry for this particular connection does not exist in the local map, the request is forwarded to the cloud service. Every BLOCK response from the cloud service can be saved locally in the local map for future consultation. There are several types of maps maintained on the client based on the type of BLOCK received from the cloud service. The process 1100 also contemplates non-HTTP/HTTPS traffic as well.

For a firewall map, if the request is forwarded to the cloud, a cloud firewall can provide the BLOCK and the decision can be provided to the local firewall map for future traffic. The updates between the application 350 and the cloud-based system 100 can be based on a tunnel. For example, a tunnel used between the mobile device 300, the application 350, and an enforcement node 150 can include information exchanged related to BLOCKs and the associated reasons. For example, DLP_VIOLATION, PROTOCOL_ACCESS_DENIED, etc. The local map can be populated based on the tunnel data.

### Disaster Recovery

As described herein, the cloud-based system 100 is designed to have high availability through redundancy, the nodes 150 being in clusters, the nodes 150 being geographically distributed, etc. Also, as described herein, the cloud-based system 100 is configured to perform security processing functions. An example of the security processing functions can include allowing or blocking data traffic. Another example of the security processing functions can include the ZTNA where the cloud-based system 100 stitches the applications 402 and the software 400 together, on a per-user, per-application basis. In normal operation, the cloud-based system 100 is available to perform the security processing. Also, in normal operation, the cloud-based system 100 can work with the mobile device 300 in a hybrid architecture.

The present disclosure contemplates use of the local map described above with the application 350 with various user device 300 (not just mobile devices 300) in the context of disaster recovery. Disaster recovery means the cloud-based system 100 is not available for a user device 300 to provide security processing. The disaster can be unavailability of one or more of the nodes 150 in the cloud-based system 100, unavailability of the entire cloud-based system 100, network congestion, network failures, etc. That is, a disaster means the cloud-based system 100 is unavailable for any reason to perform security processing.

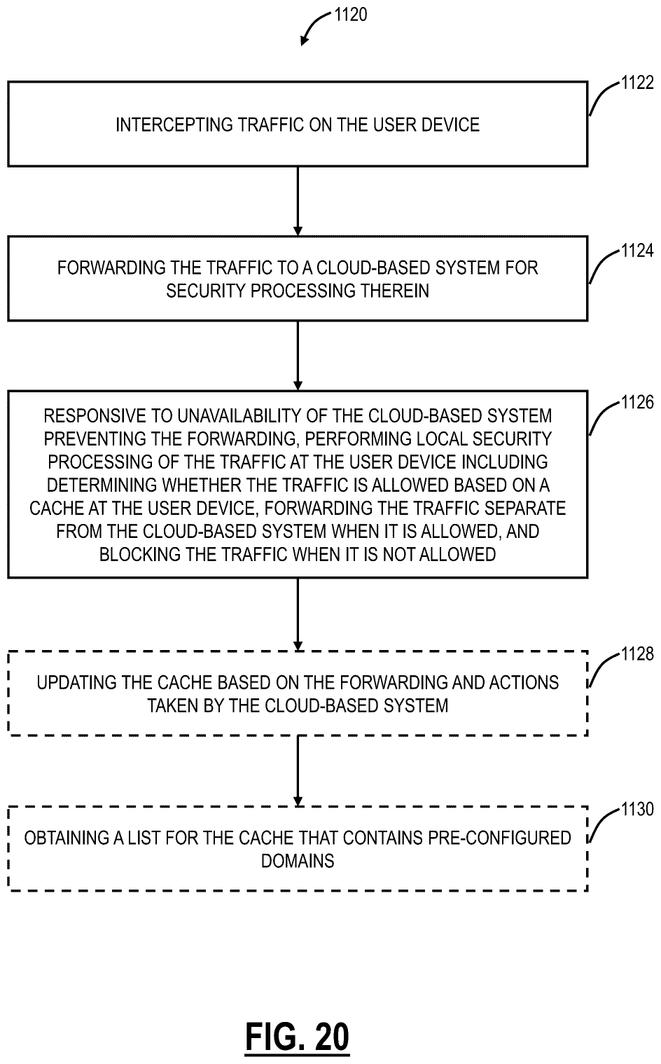

FIG. 20 is a flowchart of a process 1120 for disaster recovery via the hybrid architecture, i.e., cached policies on the user device 300. The process 1120 contemplates implementation as a method, via the user device 300, and as computer-executable instructions stored in a non-transitory computer-readable medium. The process 1120 includes intercepting traffic on the user device (step 1122); forwarding the traffic to a cloud-based system for security processing therein (step 1124); and, responsive to unavailability of the cloud-based system preventing the forwarding, performing local security processing of the traffic at the user device including determining whether the traffic is allowed based on a cache at the user device, forwarding the traffic separate from the cloud-based system when it is allowed, and blocking the traffic when it is not allowed (step 1126).

The user device 300 may or may not utilize the application 350. The user device 300 is configured to intercept outbound traffic, such as described herein, to send to the cloud-based system 100 for security processing therein. The user device 300 can determine the cloud-based system 100 is unavailable for the forwarding, and then perform the local security processing. In an embodiment, the local security processing includes a local allow/block of traffic based on cached policies, e.g., in the local map.

The process 1120 can further include updating the cache based on the forwarding and actions taken by the cloud-based system (step 1128). That is, in an embodiment, the cache can be based on monitoring the user's activity, the decision by the cloud-based system 100, e.g., block/allow, and storing the same in the cache. The process 1120 can further include obtaining a list for the cache that contains pre-configured domains (step 1130). Here, the cloud-based system 100 can provide a pre-configured list. For example, the list can be based on a tenant associated with the user device 300. Also, the list can be based on a list of top domains, such as from Alexa or the like. Also, the cache can be a combination of a pre-configured list and learned behavior from operation.

In an embodiment, for the local security processing, the traffic is blocked based on a domain included in the cache. That is, the cache can include blocked domains as well as possible allowed domains. In another embodiment, for the local security processing, the traffic is blocked based on a domain not being in the cache. Here, the cache is an allowed list and any domain not in the cache is blocked. Of course, the local security processing can include any of these operational approaches.

The process 1120 can further include maintaining access logs locally at the user device for the local security processing; and forwarding the access logs to the cloud-based system after it is available. Here, there can be some amount of logging locally maintained while the cloud-based system 100 is unavailable to ensure visibility. The unavailability can be based on the cloud-based system being down beyond a threshold. The local security processing can be configured by a tenant. For example, a tenant may allow this local security processing as well as prevent it (here, unavailability of the cloud-based system 100 would mean no network access).

The local security processing can include other approaches besides allowing/blocking a domain. For example, the local security processing can include Zero Trust Network Access to an application included in an enterprise network, and the process 1120 can include providing a secure connection to the application 402 included in the enterprise network 404 based on the cache. Other local security processing techniques can include DLP and the like.

### Disaster Recovery for Cloud-Based Monitoring of Internet Access

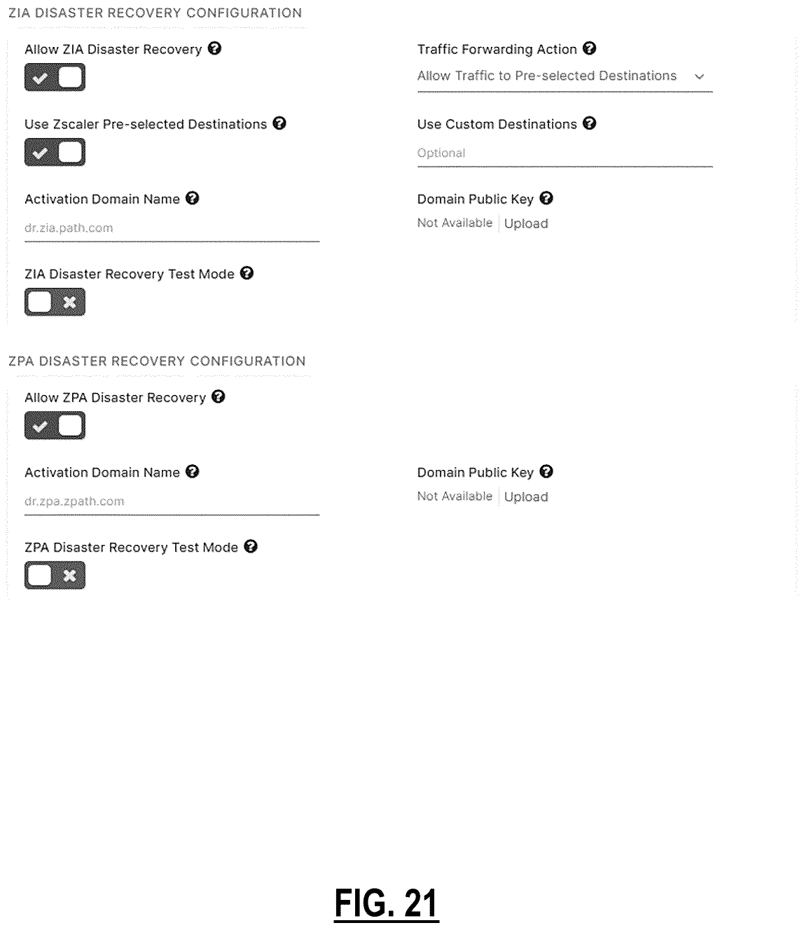

Present systems and methods allow for customized disaster recovery configurations for specific tenants, clients, users, etc. Such configurations can be enabled per application profile allowing configurations to be group based. Various configurations allow for different actions to take place in the event of a disaster recovery requirement. In various embodiments, configurations set for disaster recovery can cause systems to send traffic directly, disable internet access, allow traffic to preselected destinations (i.e., an allowed list of destinations), and the like. FIG. 21 is an embodiment of a disaster recovery configuration page.

Preselected destinations can include global default destinations preselected by a cloud provider (default lists), customer defined destinations (customer lists), and a combination thereof. These preselected destination lists can cause systems to allow or block the entries in the lists. In various embodiments, when the “allow traffic to preselected destinations” mode is chosen, and a default list and one or more customer lists exist, systems can be adapted to first check the customer lists before consulting the default list. Also, in various embodiments, if selected, customer defined items will win in the event of a conflict between default preselected destinations and customer defined destinations. Thus, the customer defined destination lists take priority over the global default destination list. Customer defined lists of destinations can be structured as a Proxy Auto-Configuration (PAC) file.

In order for a user (administrator) to configure a disaster recovery mode which disables internet access, the administrator can navigate to a specific tenant in the configuration page. In an application profile, various options can be edited including enabling a disaster recovery option. Responsive to the disaster recovery option being selected, an activation domain name can be configured. For the configured domain name, a TXT record can be created (discussed further herein). In order to disable internet access in response to the disaster recovery mode being enabled, a “disable internet access” option is selected in the configuration page. To verify the operation, the TXT record is changed to activate disaster recovery mode for monitoring of internet access. All access to any internet websites should not work responsive to the activation.

In order to set other configurations such as send traffic direct, and allowing based on pre-selected destinations, the steps are the same but include selecting the associated configuration in the configuration page (i.e., send traffic direct, and allow traffic to pre-selected destinations. Similarly, the disaster recovery can be tested, where all access to all websites will be allowed for the “send traffic direct” mode, and only websites from the predefined list will be allowed access for the “pre-selected destinations” mode.

### Disaster Recovery for Cloud-Based Private Application Access

Present systems and methods additionally allow for customized disaster recovery configurations for private application access. Such configurations can be enabled per application profile allowing configurations to be group based. Again, various configurations allow for different actions to take place in the event of a disaster recovery requirement. In various embodiments, configurations can cause systems to provide private application access during disaster recovery.

In order to configure disaster recovery for private application access, a DNS domain is provided on a mobile admin to push it to a client connector and on a private access admin UI to push it to a Private Service Edge (PSE). In various embodiments, disaster recovery must be enabled on one or more PSEs, application segments, and application connectors. Such configurations can be enabled in a private access portal.

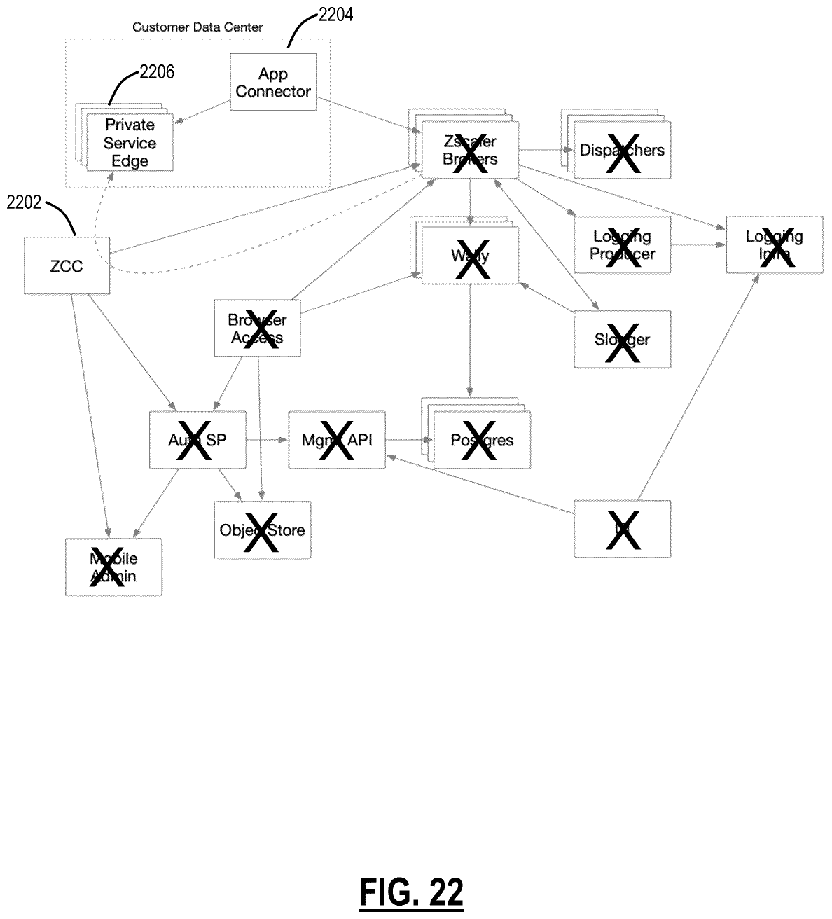

FIG. 22 is a network diagram of the cloud-based system during activation of disaster recovery. In the event of the disaster recovery mode being enabled, various functions are not available including logging, per-user authorization, browser access, enrollment of new clients, configuration changes, and the like. In various embodiments, log buffering can be implemented on disk for one or more PSEs. With disaster recovery mode, traffic forwarding and access to key applications for partly-authorized users (i.e., via client connector enrollment certificate) is available. The intention of disaster recovery is to be utilized during a cloud outage. Third parties are needed to trigger disaster recovery due to the cloud being out of service. In various embodiments, DNS allows for customer specific disaster recovery activation. Additionally, DNS records can be signed to ensure anti-tampering.

In various embodiments, a DNS record generation tool can be used to activate DNS recording. A user can install the DNS record generation tool and run as an administrator. The administrator can then chose to sign the DNS record name used to trigger disaster recovery. Further, the administrator can chose to enable the disaster recovery domain name, disable the disaster recovery domain name, or test the disaster recovery mode. Disaster recovery can then be started with an associated start time. A default end time will be presented with the interface allowing the user to accept the default time (for example, 7 days later), designate a custom end time, or ignore the end time request resulting in no expiration. The resulting DNS TXT record is provided.

In various embodiments, a test mode can be enabled, wherein the test mode triggers disaster recovery without DNS changes. It allows for testing of disaster recovery without company (enterprise) impact, while policy updates notify devices to activate disaster recovery mode.

Disaster recovery mode is an alternative to the standard logical law and system behaviors that govern various private access components. Such components can include client connectors 2202, application connectors 2204, and Private Service Edges (PSEs) 2206. Disaster recovery mode is preconfigured before a disaster, wherein the configuration determines various characteristics. The configuration can specify alternative endpoints (and propagate/cache them to the aforementioned components), activation criteria, application configuration (i.e., specifically what applications are allowed to function), and authentication (or no authentication). In various embodiments, disaster recovery can be manually activated via an activation switch which is protected from abuse. Additionally, disaster recovery mode can self-activate in specific scenarios. In embodiments, disaster recovery mode can deactivate automatically if it believes the system is capable of servicing traffic normally. For example, the disaster recovery mode can regularly check (at preconfigured time intervals) if the system is capable of servicing traffic normally. This can be manually overridden if automatic deactivation turns out to be wrong.

In an example use case, a cloud provider can push out a bad code update for private application access systems. During revert, all systems can be corrupted and become complete unreachable with no ETA for the service to come back online. Customer administrators can make the decision to go into disaster recovery mode for private application access. When enabled, users with client connector can still access internal applications or require a PSE if the configurations require. Access to such applications is not exposed to unauthorized users. Various embodiments can also include roll based access on which users can activate disaster recovery mode.

In various embodiments, when disaster recovery mode is enabled, transactions are logged (can be stored and sync′d later), on premises users (without client connector) can also access internal applications, browser only access is allowed for roaming users, and users are notified that they are temporarily in disaster recovery mode. Embodiments also allow (if configured) automatic failover if private application access systems are down and disaster recovery cannot be manually activated.

The various solutions described herein provide VPN-like access to private applications using private application access infrastructure and PSEs. Various approaches rely on a local config files being present at application connectors and PSEs during a disaster or when the cloud is unavailable. Configurations can be overridden locally via local config files, where local and cloud config files can co-exist and local config files take precedence over cloud config files. Again, config files on connectors and PSEs dictate what is accessible during an event (when disaster recovery is activated).

### Private Broker Disaster Recovery

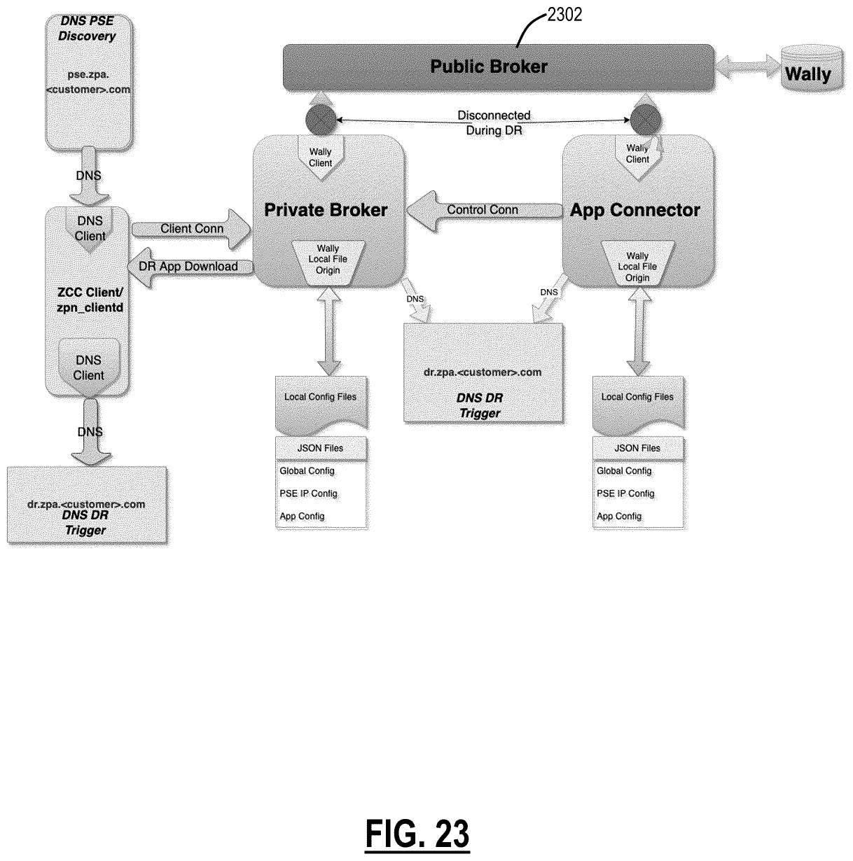

FIG. 23 is a network diagram of private broker disaster recovery components. Prior to a disaster recovery event, an administrator associated with the cloud-based private application access creates a cloud configuration which includes designating disaster recovery mode applications and PSEs via an administrator UI. The cloud configuration is distributed to PSEs and application connectors (cloud-based system components). Both the PSEs and application connectors write a copy of their cloud configurations into local configuration files (or update existing configuration files) if configuration has changed. Normal application access continues for the entire set of applications.

During a disaster recovery event, an administrator associated with the customer initiates disaster recovery mode and sets a DNS TXT-record key to a special secure value to trigger disaster recovery mode. The administrator additionally sets DNS A-record to point to a desired set of preselected disaster recovery PSE instance IP's. It is noted that disaster recovery for cloud-based monitoring of internet access, and disaster recovery for cloud-based private application access can be activated individually or separately. Responsive to activation of disaster recovery for cloud-based private application access, both PSEs and application connectors check if the DNS disaster recovery trigger is on. Both application connectors and PSEs switch to disaster recovery mode by restarting. Both application connectors and PSEs read a copy of their cloud derived configurations from their configuration files. All application connectors connect to disaster recovery mode PSEs based on the PSE IP configuration. PSEs load all disaster recovery mode applications based on the application list in the configuration file. Client connectors detect that the DNS disaster recovery trigger is on via the TXT record and connect to a disaster recovery mode PSE by resolving and using a PSE IP for DNS A-record name. The list of disaster recovery applications is downloaded to the client connectors based on the disaster recovery applications listed in the configuration file. The client connectors will forward tunnels from disaster recovery applications to the PSEs to connect.

Various embodiments contemplate the use of automated configuration file generation. Again, when connected to the public broker 2302, data is received to generate local copies of cloud derived PSE configurations. Separate configuration files can include global configuration files, application list configuration files, PSE IP configuration files, and the like. The various configuration files are subsequently organized into two distinct hierarchies including cloud derived configurations and local overridden configurations. Separate configuration files for different parameters are organized into files including current disaster recovery on/off status (global configuration file), PSE IP list (PSE IP configuration file), authentication interval during disaster recovery mode (global configuration file), disaster recovery application list (application list configuration file), authorization timeout (global configuration file), IDP configuration (global configuration file), etc.

Similarly, when connected to the public broker 2302, data is received to generate local copies of cloud derived application connector configurations. As was stated for the PSE configurations, separate configuration files can include global configuration files, application list configuration files, PSE IP configuration files, and the like. Again, separate configuration files for different parameters are organized into files including the files disclosed previously.

Various embodiments contemplate automatic configuration dump and configuration snapshots. The running configuration can be dumped to disk on application connectors and PSEs for use during disaster recovery. Systems save the running configuration from memory to disk (if anything has changed) periodically in at fixed intervals (i.e., every 15 minutes) considering current running configuration has reached a longer quiesce/quite state and is stable/unchanged for over a predetermined time interval (for example, 5 minutes). Systems are also adapted to maintain historical configuration snapshots on application connectors and PSEs for use during disaster recovery events for fallback purposes. Systems can create a daily configuration snapshot at a fixed time every day. The snapshot trigger time can be settable/changeable via configuration override, defaulting to a set time every day (i.e., 2:00 AM every day). Embodiments include support for purposes of disaster recovery to allow simultaneously having multiple configuration versions being present on a system.

During a disaster recovery event, it may become necessary to use an older version of configuration if the current version of the configuration is corrupted or otherwise unsuitable for some other reasons. Thus, various embodiments include support for maintaining multiple configuration snapshots. Each disaster recovery configuration snapshot directory is formatted by embedding a timestamp into the directory name. Each system can maintain up to 15 daily prior configuration snapshots, both PSEs and application connectors periodically check and delete old configuration snapshots automatically that are older than a set interval (i.e., 15 days from current date).

Similarly, during a disaster recovery event, it may become necessary to use an older version of a binary if the current version of binary is unsuitable or incompatible with the version of configuration currently in use. Thus, embodiments support maintaining multiple binary snapshots. Each binary snapshot directory contains both the binary image file and the image version metadata file to encapsulate the state of a valid system binary. Each system can maintain up to 5 prior binary snapshots, both PSEs and application connectors will periodically check and delete old binary snapshots automatically that exceed total 5 binary snapshots limit and are older than a set time interval (i.e., 30 days). The configuration snapshot directory will contain a file with a running binary version inside the metadata file, this file will be copied into the daily snapshots directory to indicate what binary was used with the given configuration snapshot.

No policy is enforced when disaster recovery mode is active. Thus, user certificates are tested for signature validity, but not checked for certificate revocation, certificates have a validity of one year from the date they are issued/enrolled. Recently terminated employees (up to the disaster recovery auth age) could have access to applications when in disaster recovery mode. Mitigation of this includes deleting the client certificate from client connectors for terminated employees to avoid this situation. SAML re-auth time is extended during disaster recovery mode. Thus, systems extend the validity of expired SAML assertion beyond its original validity by an additional 14 days, or other period, by default (relative to the start of validity date). Administrators have the option to extend validity of SAML assertion up to a total of additional 90 days. This assertion additional validity time is configurable via admin UI while the system (PSE) is still connected to the cloud. During active disaster recovery while the PSE is disconnected from the cloud (Broker) an administrator may manually extend the SAML assertion validity by editing local config file and putting a higher value for auth interval and manually restarting each PSE. Disaster recovery mode does not disable the cloud, when customer systems go into active disaster recovery mode they simply do not connect or use cloud services. Customers have the option to enable disaster recovery mode on a per-application segment basis. Only application segments marked for disaster recovery will be allowed access during disaster recovery mode. Only application connector groups and PSE groups marked for disaster recovery will be used in disaster recovery mode. Customers can use an “Allow Disaster Recovery” or “Allow Disaster Recovery Test Mode” configuration in the application profile to control which set of users are able to participate in disaster recovery mode.

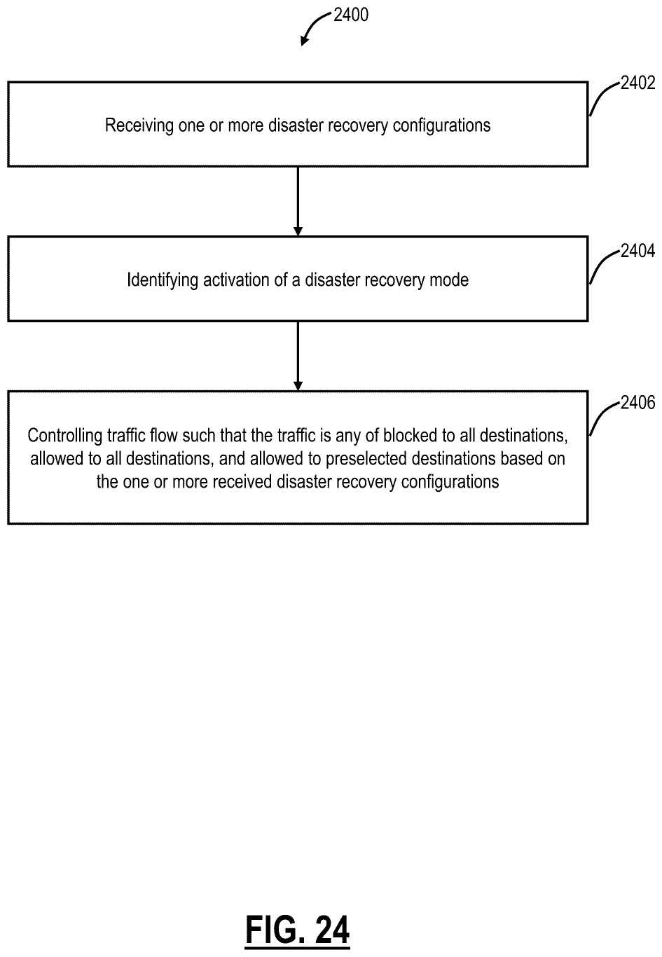

FIG. 24 is a flow chart of a process 2400 for disaster recovery for cloud-based monitoring of internet access. The process 2400 includes receiving one or more disaster recovery configurations (step 2402); identifying activation of a disaster recovery mode (step 2404); and controlling traffic flow such that the traffic is any of blocked to all destinations, allowed to all destinations, and allowed to preselected destinations based on the one or more received disaster recovery configurations (step 2406).

The process 2400 further includes updating a cache based on the actions taken during activation of the disaster recovery mode. The one or more disaster recovery configurations can each be associated with one or more specific tenants of a cloud-based system. The one or more disaster recovery configurations include a list of global default destinations preselected by a cloud provider. The one or more disaster recovery configurations additionally include one or more customer defined destination lists. The one or more customer defined destination lists take priority over the list of global default destinations. The list of global default destinations and the customer defined destination lists include domains which are instructed to be one of blocked or allowed.

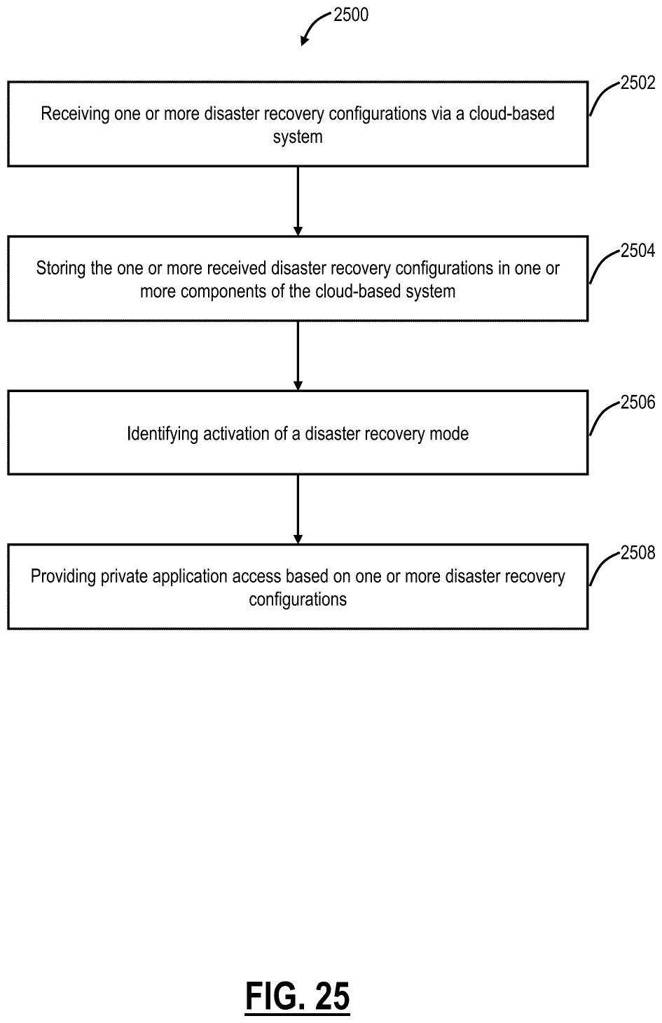

FIG. 25 is a flow chart of a process for disaster recovery for cloud-based private application access. The process 2500 includes receiving one or more disaster recovery configurations via a cloud-based system (step 2502); storing the one or more received disaster recovery configurations in one or more components of the cloud-based system (step 2504); identifying activation of a disaster recovery mode (step 2506); and providing private application access based on one or more disaster recovery configurations (step 2508).

The process 2500 further includes wherein the one or more disaster recovery configurations are each associated with one or more specific tenants of the cloud-based system. The one or more disaster recovery configurations include which components of the cloud-based system will be utilized during active disaster recovery mode. Private application access is only provided to disaster recovery applications specified in the one or more configurations. The one or more components of the cloud-based system update their stored configurations based on one or more new configurations. The one or more components of the cloud-based system store a plurality of configurations, and wherein any of the stored configurations can be used responsive to activation of the disaster recovery mode. The activation of the disaster recovery mode is one of automatically activated and activated by an administrator associated with a tenant.

### Private Application Access Continuity

Ensuring business continuity for mission-critical IT systems has become a top priority for customers due to recent cloud outages and increasing regulatory pressures. In response to this critical need, the present disclosure provides an innovative solution for Zscaler Private Access (ZPA) (private application access) that offers automated business continuity and disaster recovery in the event of a widespread cloud outage. The solution, encapsulated in the form of a site controller, is an on-premises version of the private application access control plane. The site controller is designed to deliver essential services such as authentication and load balancing from a Virtual Machine (VM) that operates independently of the public cloud and is hosted by the customer. This ensures that critical services remain operational regardless of the status of the public cloud. The site controller provides automated business continuity, rapid disaster recovery capabilities, and operates in full isolation from the public cloud, offering the flexibility and control of being customer hosted.

This solution described herein will further enhance customers' ability to maintain uninterrupted access to critical IT services, even in the face of significant cloud disruptions. By implementing these solutions, customers can be provided with robust, reliable, and automated business continuity options that safeguard their mission-critical IT systems against unforeseen outages and ensure compliance with regulatory requirements.

In various embodiments, the present functions are referred to as an “offline mode” and as Denied, Disrupted, Intermittently Disconnected, and Limited bandwidth (DDIL) mode. This can also be contemplated as disaster recovery mode as described herein.

A key feature of the present DDIL mode includes allowing users, during a cloud outage, to be able to continue accessing applications that are reachable based on current access policies. That is, users that are enrolled with the unified agent application 350 will continue to have access during a cloud outage. Additionally, new users that are not yet enrolled with the unified agent application 350 will also have access to applications in DDIL mode. User authentication can be enforced through local IDP integrations. All applications configured by the customer prior to DDIL mode taking effect will be available to users and all applications that are reachable from on-site application connectors will be available to users. All policies configured by the customer prior to DDIL mode being activated are enforced for both existing and new users. In order to facilitate connections without the cloud, load balancing user traffic across multiple Private Service Edges (PSEs) 2206 within a site is also supported. Components associated with private application access are adapted to automatically transition into and out of DDIL mode. Further, components associated with private application access are adapted to log transactions that take place during the outage.

Again, a Private Service Edge (PSE) 2206 is a dedicated component within the architecture of the cloud-based system 100 that delivers security, policy enforcement, and traffic routing capabilities tailored specifically for an organization. Unlike the public cloud infrastructure, i.e., the cloud-based system 100, which serves multiple customers, a PSE 2206 is exclusively allocated to a single customer and is typically deployed within the customer's own data center or private cloud environment. This dedicated infrastructure ensures that performance and security measures are customized to the organization's specific needs. The PSE 2206 enforces security policies such as web filtering, DLP, and access controls, while also managing traffic between users and applications both within the corporate network and to external destinations. By being deployed closer to the users and applications it serves, the PSE 2206 reduces latency and enhances performance. Additionally, it integrates seamlessly with the Zero Trust Exchange, maintaining centralized management and consistent policy enforcement across both private and public environments. This makes the PSE 2206 a crucial solution for organizations requiring robust security, compliance with regulatory requirements, and optimized performance.

Various components are involved to provide the present functionalities including the unified agent application 350, customer provided DNS, IDP, MDM, and SIEMs that are accessible by cloud components on the customer site, on customer site PSEs 2206, application connectors 2204, and a site controller work together to support a set of use-cases that do not require availability of the cloud-based system 100. The various components described herein can be contemplated as belonging to an on-site disaster recovery system. That is, the on-site disaster recovery system includes the site controller 2604, the various PSEs 2206, and the various application connectors 2204.

Each customer site supporting offline mode is associated with an offline domain name (offline domain), configured by the customer. Various components in the system will use this offline domain as a suffix. It shall be noted that the offline domain name can be per-site. FQDNs and SNIs will be suffixed by the offline domain and during provisioning, the site controller will request a single server certificate for all services it runs.

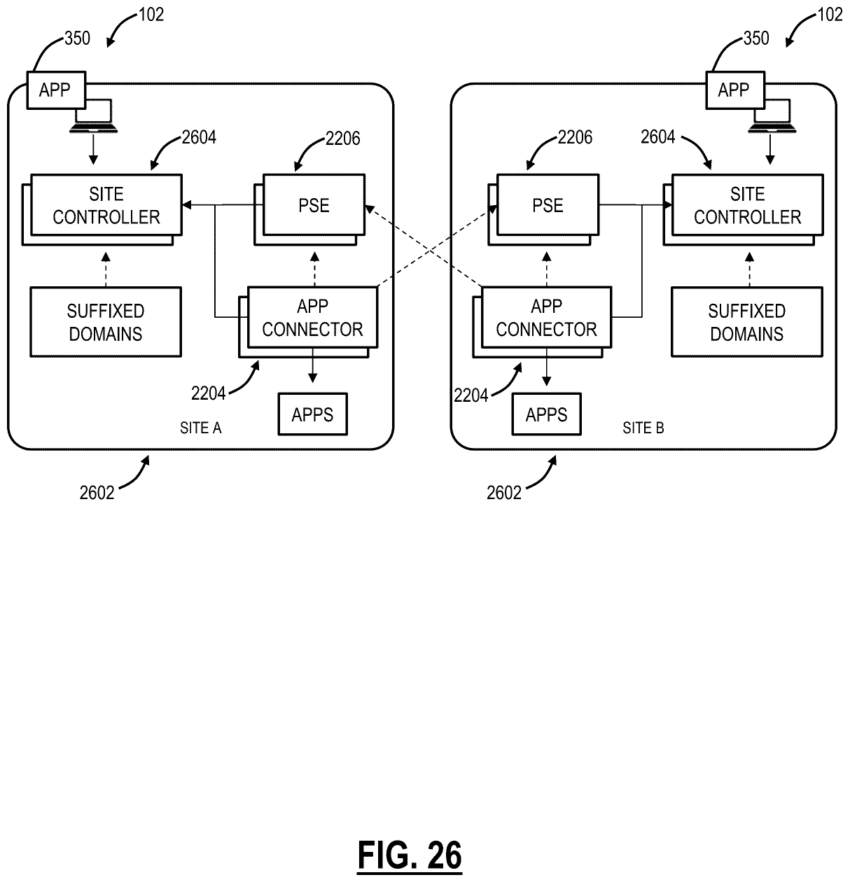

FIG. 26 is a flow diagram depicting a customer having a plurality of sites. In this example, the customer has the sites 2602 (site A and site B). In various embodiments, customers can deploy a plurality of sites 2602, and all sites 2602 can be logically under a single customer offline domain. That is, each site 2602 is associated with a specific offline domain, where all of the customers offsite domains are under a customer offline domain. Which site 2602 a unified agent application 350 connects to depends on the DNS configuration of the site 2602, and customer provided infrastructure can be cross-sites, as long as they are accessible from all sites 2602.

In various embodiments, when the activation of DDIL mode is determined by the unified agent application 350, the unified agent application 350 can decide to connect to a specific site controller 2604 based on the geo-location of the device/user. That is, site controllers 2604 are associated with specific sites of the tenant, and the unified agent application 350 can connect to a specific site controller 2604 based on the users location.

In order to set up a site 2602 to support DDIL mode, the following method is followed. It will be appreciated that the process to set up a site 2602 to support DDIL mode can be performed by an administrator of a customer through a provided administration portal/UI. Via an offline domain page of the administration portal, an offline domain must be specified. Once specified, the portal can present a site controller group page. Via the site controller group page, a plurality of sites 2602 can be created, each having the following configuration options.

### Select the IDP to Use Under DDIL Mode.

Select an Authentication Service Provider (AuthSP) signing certificate. When saved: API creates a private signing key per-site, encrypted by a crypto service and then then stored in a database. The API generates per-tenant AuthSP metadata. The portal/UI displays a link to download the per-site AuthSP metadata. The UI displays the per-site AuthSP metadata URL.

Signing certificate of site controller's enrollment certificate. This information is synced (for offline configuration generation).

Re-enrollment interval (monthly, quarterly, 6-months) for DDIL components (PSEs, Connectors and Controllers).

The administrator can associate instances (PSEs, Connectors and Site Controllers) with sites 2602.

Further, via a site controller page, the administrator can add site controllers. This can be done by selecting a site controller group and selecting or creating a provisioning key which is used to tie to the site controller group's enrollment CA. The various provisioning keys used for enrollment can be displayed within a site controller provisioning keys page.

For DDIL mode, a private key of the AuthSP must be made available to site controllers for request signing. Therefore, when the AuthSP is created under the site controller group, the private key is encrypted and stored. Then the site controller receives the encrypted private key and requests decryption. The decrypted private key is then re-encrypted and stored on the site controller. When requested, the site controller loads the private key from a local disk.

During runtime, the unified agent application 350 can implement the following behavior. Until the unified agent application 350 logs into the private application access system successfully, the unified agent application 350 tries to connect to the cloud broker. If this fails, the unified agent application 350 tries to then connect to a backup cloud broker. If this fails, the unified agent application 350 then tries to connect to the broker in the DDIL configuration. Similarly, the PSE 2206 and application connectors 2204 will, if DDIL mode is in effect, accept connections via the domain suffixed by the offline domain.

The site controller 2604 is a new component designed to act as an “on-premises broker,” ensuring the continuity of essential functionalities when the cloud is unavailable. It fulfills critical roles required by the Private Service Edge (PSE) 2206 and application connectors when the cloud-based system 100 is not available, and acts as a proxy for these functionalities through public brokers when the cloud is accessible. The site controller 2604 is responsible for several shared, per-site functionalities.

Firstly, the site controller 2604 downloads and persists a complete copy of the customer configuration and user data. This data is then distributed to the PSEs 2206 and application connectors on-site, ensuring that these components have the necessary information to operate independently of the cloud. Additionally, the site controller 2604 serves as the Authentication Service Provider (AuthSP) under DDIL mode, performing evaluations necessary to maintain security and access protocols in such scenarios. Moreover, the site controller 2604 integrates with logging and Security Information and Event Management (SIEM) systems, providing critical insights and data for monitoring and analysis. It also functions as a redirect broker, managing and redirecting traffic as needed to maintain optimal operation and connectivity. The site controller 2604 plays a critical role in ensuring that services continue to function smoothly in the absence of cloud connectivity, while also enhancing the overall resilience and reliability of the network infrastructure. Again, the site controller 2604 can also perform load balancing by redirecting to one or more PSEs 2206.

As stated, a site controller 2604 plays a crucial role in maintaining the functionality and security of network operations when connectivity to the primary cloud infrastructure is compromised. A detailed summary of what a site controller does in DDIL mode includes:
User Authentication: The site controller 2604 takes over the responsibility of authenticating users locally when the primary authentication services in the cloud are unavailable. This ensures that users can still gain access to critical applications and services.
SAML Authentication: It performs Security Assertion Markup Language (SAML) authentication, validating user credentials and issuing authentication tokens locally.
Access Control: The site controller 2604 enforces security and access policies that are typically managed by the cloud-based system 100. This includes ensuring that only authorized users can access specific resources.
Security Policies: It applies security policies such as web filtering, data loss prevention (DLP), and threat protection as defined by the organization.
Load Balancing: The site controller 2604 manages and balances the traffic load to ensure efficient use of local network resources, preventing any single point of failure.
Redirection: It redirects user traffic to the appropriate local resources or PSE 2206 within the site, ensuring seamless connectivity.
Business Continuity: By taking over critical functions, the site controller ensures that business operations can continue uninterrupted even during a cloud outage.
Disaster Recovery: It provides rapid recovery capabilities to restore normal operations as quickly as possible.
Local Logging: The site controller 2604 logs all access attempts, traffic flows, and security events locally. This data can be crucial for troubleshooting, compliance, and security audits.
Integration with SIEM: It can integrate with local Security Information and Event Management (SIEM) systems to provide real-time monitoring and alerting.
Intermittent Sync: When connectivity is intermittently available, the site controller 2604 syncs with cloud services to update policies, user credentials, and other critical information.
Fallback Mechanism: It acts as a fallback mechanism, ensuring that essential services remain operational until full connectivity to the cloud is restored.

Thus, in DDIL mode, the site controller 2604 ensures that the organization's network remains secure and functional even when connectivity to the primary cloud infrastructure is compromised. It takes over local authentication, policy enforcement, traffic management, and logging, providing a robust solution for business continuity and disaster recovery. By maintaining these critical functions locally, the site controller ensures that users can access necessary resources securely and efficiently, minimizing the impact of cloud outages on business operations.

Further, PSEs 2206 also play a critical role when in DDIL mode. In DDIL mode, a PSE 2206 maintains the functionality, security, and connectivity of an organization's network when connectivity to the primary cloud infrastructure is compromised. Key functionalities of a PSE 2206 include:
Traffic Management: The PSE 2206 manages and routes traffic between users and applications within the local network. This ensures that internal communications and access to local resources continue uninterrupted, even when cloud connectivity is impaired.
Bandwidth Optimization: It optimizes the use of available network bandwidth to maintain the performance of critical applications and services.

Additionally, PSEs 2206 and application connectors 2204 work together to ensure that users can continue to securely access applications even when connectivity to the primary cloud infrastructure is compromised. The PSEs 2206 handle local traffic management, ensuring that user requests are efficiently routed to the appropriate application connectors 2204 within the local network. The application connectors 2204 are then responsible for connecting users to the internal applications they need to access. It acts as a bridge between the user and the application server. The PSE 2206 works with the site controller 2604 to authenticate users locally. This ensures that user credentials are verified even when the primary cloud-based authentication services are unavailable. Once the user is authenticated, the PSE 2206 passes the necessary authentication tokens to the appropriate application connector 2204, which validates these tokens before granting access to the application. The PSEs 2206 ensure that critical services such as authentication, policy enforcement, and traffic management continue to operate smoothly during cloud outages. By working with the PSEs 2206, the application connectors 2204 maintain continuous access to applications, ensuring that users can still perform their tasks without disruption.

The PSEs 2206 can manage load balancing across multiple application connectors 2204, optimizing the use of available resources and preventing any single point of failure. The application connectors 2204 can quickly respond to user requests and direct traffic to the appropriate application servers, leveraging the resource management capabilities of the PSEs 2206.

As described in various embodiments herein, the management and activation of disaster recovery/DDIL mode can be performed automatically. In an embodiment, the site controller 2604 maintains a setting with three possible values. These values include (i) off, where the site controller 2604 and PSEs 2206 do not support DDIL endpoints until this setting is changed, (ii) on, where the site controller 2604 and PSEs 2206 do support DDIL endpoints until this setting is changed, and (iii) auto, where the site controller 2604 decides whether itself and PSEs 2206 should support DDIL endpoints depending on the network situation that the site controller 2604 is experiencing at any given point in time. A PSE 2206 does not make its own decision about activating DDIL mode. Instead, it receives the knowledge through its control connection to the site controller 2604. When a PSE 2206 or site controller 2604 is not under DDIL mode, if a client connects to it, it can do one of the following. Reject the connection where clients with a retry logic will naturally retry the ZPA cloud. Allow the connection but send an explicit error.

When in “auto” mode, the site controller 2604 can determine the DDIL mode based on its control connection to a private access public broker. The exact criteria are implementation dependent.

### DDIL Criteria

Customers who deploy PSEs 2206 may wish to have their users connect to PSEs 2206 under certain circumstances including under normal operation conditions with trusted networks and redirection policies as well as when there is an issue with the private access public cloud, i.e., the cloud-based system 100. When there is an issue with the cloud-based system 100, the systems can utilize the PSEs in aggressive, semi-aggressive, and conservative approaches. An aggressive approach will connect to PSEs immediately when there is an issue with cloud connectivity. A semi-aggressive approach gives the cloud time to recover and tries for several minutes, i.e., 1-30 minutes, and then connects to PSEs. A conservative approach can allow the cloud to recover for longer periods of time before switching. The time defined above will vary from customer to customer. By implementing such processes, customers can have control over their environment if there is an outage affecting their private application access.

In various embodiments, the unified agent applications 350 operating on user devices can decide when to transition into DDIL mode. The unified agent application 350 offers three modes of operation for managing its connection behavior. The first mode, “FORCE ON,” forces the unified agent application 350 to fall back to a site controller 2604 and establish a connection with a PSE. The second mode, “FORCE OFF,” compels the unified agent application 350 to connect directly to public brokers, provided it is not already connected to one. The third mode, “AUTO,” allows the unified agent application 350 to automatically detect its connectivity to the cloud and switch to a site controller if the public cloud experiences downtime. Additionally, in “AUTO” mode, administrators can configure the maximum allowed downtime in minutes, specifying how long the unified agent application 350 should wait before determining that the cloud is unavailable and initiating a switch to the site controller 2604.

When in auto mode, the failover operation from the cloud-based system 100 to the site controller 2604 can be as follows.

### For Enrolled Users:

When an enrolled user is not authenticated, the unified agent application 350 will try to reach the SAML Service Provider (SAML SP) component that handles authentication for the cloud-based system 100. If the SAML SP is not reachable, the unified agent application 350 connects to a site controller 2604 for doing SAML authentication. Once the SAML authentication is done by the site controller 2604, the unified agent application 350 contacts a broker service and gets redirected to a public broker if it is reachable. If the broker service is not reachable, then the unified agent application 350 connects to a site controller 2604 and the unified agent application 350 connection finally gets redirected to a PSE 2206 within the site 2602.

When an enrolled user is authenticated, the unified agent application 350 will try the broker service. If DNS resolution to the broker service fails or if the unified agent application 350 is not able to connect to any of the redirect broker IP addresses (provided as part of DNS resolution), then the unified agent application 350 will switch to the site controller 2604 and get redirected to a PSE 2206 within the site 2602.

When the unified agent application 350 is connected to a public broker and the connection is idle for 60 seconds, the unified agent application 350 will start sending FOHH status requests to the broker and there is no FOHH status response from the broker. In this case, the unified agent application 350 will try to connect to the next available public broker in the redirect list. If it is not able to connect to any of the brokers in the list, then the unified agent application 350 will switch to site controller 2604 and get redirected to a PSE 2206 in the site 2602. When the unified agent application 350 is connected to the public broker and working, the unified agent application 350 will not perform any probe to the broker service.

It will be appreciated that an FOHH status request is a mechanism used to periodically send requests to verify if a connection to a broker is active and responding.

### For New Users:

The unified agent application 350 tries to reach SAML SP. If the resolution fails or it is not able to connect to any of the resolved SAML SP IP addresses, then the unified agent application 350 will connect to a site controller 2604 for doing authentication. The unified agent application 350 creates a self-signed certificate and uses that certificate to connect to the site controller 2604 and PSE 2206. Once the authentication is done, the unified agent application 350 will have a SAML assertion token with the audience as the site-specific service provider. The unified agent application 350 uses this assertion and makes a connection to the site controller 2604 again. The site controller 2604 validates the assertion and redirects the unified agent application 350 to a PSE 2206 in the site 2602. The unified agent application 350 uses the same SAML assertion and connects to the PSE 2206.

When in auto mode, the failover operation from the site controller 2604 to the public cloud can be as follows.

### For Enrolled Users:

Once the unified agent application 350 gets connected and authenticated to a PSE 2206, it will send an RPC message to the PSE 2206 to indicate whether it is in DDIL mode or not. This information is required by the PSE 2206 because for enrolled users it listens to the same SNI and the PSE 2206 will not be able to differentiate between the connections coming to PSE 2206 due to DDIL condition or due to normal operation.

The PSE 2206 monitors each unified agent application 350 connection and sends a switch_to_cloud RPC message to the unified agent application 350 to switch to the public broker if all the below conditions are met.

The unified agent application 350 connection is in DDIL mode.

There are no tunnels on this connection.

PSE 2206 to public broker connection is UP (ZPA cloud up from PSE perspective).

The unified agent application 350 connection to PSE 2206 is connected for more than 10 mins (This is to avoid the unified agent application 350 trying to switch to public broker more frequently)

Once the unified agent application 350 receives a switch_to_cloud RPC message, it will do the following. If the unified agent application 350 operation mode is not auto, then the connection stays with the PSE 2206. If the operation mode is auto, it will try to resolve and connect to the redirect broker. It will then get the redirect list and connect to the public broker. If it fails in any of the steps, then it will fallback to PSE 2206 via site controller redirect.

### For New Users:

The PSE 2206 monitors all the connections and sends a switch_to_cloud RPC to the unified agent application 350 if all the below conditions are met.

There are no tunnels on this connection.

PSE 2206 to public broker connection is UP (ZPA cloud up from PSE perspective).

The unified agent application 350 connection to PSE 2206 is connected for more than 10 mins (This is to avoid the unified agent application 350 trying to switch to public broker more frequently)

Once the unified agent application 350 receives a switch_to_cloud RPC, it tries the following sequence. If the unified agent application 350 operation mode is not auto, then the connection stays with the PSE 2206. If enrollment is complete, then it behaves like an enrolled user from now on and follows the enrolled user flow. If the enrollment fails due to any reason it will switch back to PSE 2206 via site controller redirect.

Redirection in the site controller 2604 can respect the following flow. When the unified agent application 350 gets a site controller 2604 IP address, the unified agent application 350 connects to the site controller 2604. Once authentication is complete, the site controller 2604 will perform the redirect process. As part of the redirection process, the site controller 2604 will ignore the redirect policies for the customer as the site controller 2604 is going to redirect to a PSE 2206 within the site based on the PSE 2206 load information and its location, i.e., load balancing. When a PSE 2206 is connected to a public broker, each PSE 2206 sends its load information to the public broker. The public broker updates a load table and the site controller 2604 receives the load information as it fully loads the load table. When a PSE is connected to a site controller 2604 (public broker down), each PSE opens up a connection to all the site controllers 2604 and sends the load information.

PSEs 2206 and application connectors 2204 can respect the following connection flow. When, in the configuration, a prefer site controller mode is set to “yes”, All ctrl/config/ovd/log/stats connections from PSEs 2206 and application connectors 2204 will connect to the site controller 2604 within the site 2602. When the site controller 2604 is down, PSEs 2206 and application connectors 2204 wait for the connection to site controller 2604 to be back up for 2 mins, if it does not come up within that timeframe it switches all the connections to the public broker and it starts a FOHH connection to the site controller 2604. Once that connection comes up, all the remaining connections are switched back to the site controller 2604.

When the prefer site controller mode is set to “no”, all ctrl/config/ovd/log/stats connections from PSEs 2206 and application connectors 2204 will connect to the public broker. When the connection to the public broker is down for 2 mins, PSEs 2206 and application connectors 2204 will switch all their connections to the site controller 2604. It also starts a FOHH connection to the public broker. Once the connection comes up the PSEs 2206 and application connectors 2204 will switch the remaining connections back to the public broker.

Transitioning between public brokers and site controllers 2604 can respect the following criteria. PSEs 2206 and application connectors 2204 switch their connection to public brokers/site controllers 2604 if the connection cannot be established within the maximum allowed downtime configuration. By default, the maximum allowed downtime value is 2 minutes. A specific retry logic is contemplated and performed by the present systems. For example, if the redirect list contains two brokers in the list (broker1, broker2), the site PSEs 2206 and application connectors 2204 will first try connecting to broker1, if they are not able to establish a connection, they will retry the connection to broker1 5 times with the backoff value of 1 seconds, 2 seconds, 3 seconds, 4 seconds, and 5 seconds for each corresponding retry. Thus, a total of 15 seconds is spent on trying the first broker in the list. If the connection attempt to the first broker fails, the site PSEs 2206 and application connectors 2204 try connecting to the second broker in the list broker2. If this also fails to connect for 15 seconds (5 retries), then they will retry the first broker again. These steps keep repeating until the connection is established. If there is only 1 broker in the list, then after 5 retries, the back off will be exponential.

Further, as described above, the present automated disaster recovery mode systems can be configured by administrators via portals/UIs. This configuration includes site 2602 configuration. As part of site 2602 configuration, PSE groups, application connector groups, and log receivers can be mapped to specific sites 2602. Based thereon, PSEs 2206 and application connectors 2204 will connect to site controllers 2604 within their site 2602. Additionally, a sites site controller 2604 will make connections to SIEM servers based on the log receiver configuration mapped to the site 2602.

There is also a DDIL configuration page which allows the below configurations.

Offline domain: Textbox to enter the offline domain.

Offline domain to IDP mapping: Drop down box to select the customers IDP.

Allow non enrolled users: Checkbox. When this option is selected, PSE 2206 and site controller 2604 will allow non-enrolled users to access private applications when in DDIL mode. When this option is not selected, PSE 2206 and site controller 2604 will not allow non-enrolled users to access private applications when in DDIL mode.

Prefer Site Controller: Checkbox. When this option is selected, PSEs 2206 and application connectors 2204 will connect to the site controller 2604 by default for ctrl/config/ovd/log/stats connections. Will switch to a public broker only when the site controller 2604 is not available. When this option is not selected, PSEs 2206 and application connectors 2204 will connect to the public broker by default for ctrl/config/ovd/log/stats connections. Will switch to a site controller 2604 only when the public broker is not available.

Maximum allowed downtime in minutes: Textbox. This configuration is to control the wait time for the connection switch between public brokers to site controller 2604 and vice versa.

In the site controller page there will be an option to disable a site controller 2604. If the site controller 2604 is disabled, it won't accept any connections from unified agent applications 350, PSEs 2206, and application connectors 2204.

The following highlights a plurality of scenarios where a unified agent application 350 will failover to a site controller 2604 and PSE 2206.

When the broker service is not reachable:

When the user is on-premises and cloud connectivity is Impacted:

Scenario: The reachability from the customer network to the cloud-based system 100 is impacted.

Action: The unified agent applications 350 will connect to the site controller 2604, which then directs the connection to a PSE 2206.

### When the User is Remote:

Scenario: While very unlikely, if it happens, it indicates a true disaster recovery scenario where all customers are impacted.
Action: The unified agent applications 350 will connect to the site controller 2604, which then directs the connection to a PSE 2206.

### ISP Issue Preventing Connection:

Scenario: Unlikely but possible, where an ISP issue prevents connection to the broker, but the site controller 2604 and PSE 2206 are still reachable.
Action: The unified agent applications 350 will connect to the site controller 2604, which then directs the connection to the PSE 2206.

The broker service is reachable but cannot connect to a broker or PSE 2206:

When the user is on-premises or remote:
Scenario: The unified agent applications 350 can reach the broker service but cannot establish a connection to a broker or PSE returned by the private access service.
Action: The unified agent applications 350 will connect to the site controller 2604, which then directs the connection to the PSE 2206.

### Tunnel Performance Deteriorates:

When the user is connected to a broker or PSE 2206:
Scenario: The tunnel performance deteriorates.
Action: Latency-based broker selection will kick in, and the tunnel will switch to a secondary tunnel, which can be a broker or PSE 2206 depending on what was returned to the unified agent applications 350 by the private access service.
Secondary Failover: If the unified agent applications 350 cannot connect to the secondary, it will connect to the site controller 2604, which then directs the connection to the PSE 2206.

ISP from data center hosting the application connector 2204 is down:

When the user is remote and connected to a broker:
Scenario: The customer's ISP from the data center where the application connector 2204 is hosted is down, resulting in no connectivity to the broker from any application connector 2204.
Action: If the site controller 2604 and PSE 2206 are hosted in the DMZ and available over the internet, the unified agent application 350 will connect to the site controller 2604, which then directs the connection to the PSE 2206.

Partial application connector 2204 availability:

What if some application connectors 2204 are available and some are not?
Action: The unified agent application 350 will connect to the site controller 2604, which then directs the connection to the PSE 2206, as mentioned above. This action will occur after the maximum allowed downtime.

### Process for Private Application Access Continuity

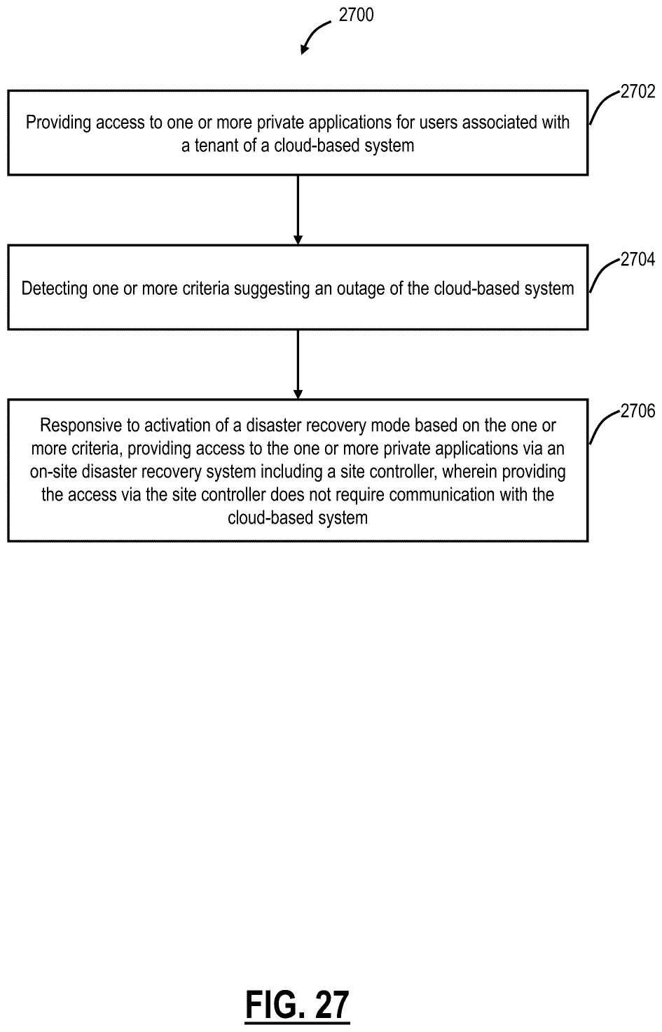

FIG. 27 is a flow chart of a process 2700 for providing private application access continuity. The process 2700 can be contemplated as a method implementing steps, a user device configured to implement the steps, and the steps as computer-executable instructions stored in a non-transitory computer-readable medium. The process 2700 includes providing access to one or more private applications for users associated with a tenant of a cloud-based system (step 2702); detecting one or more criteria suggesting an outage of the cloud-based system (step 2704); and responsive to activation of a disaster recovery mode based on the one or more criteria, providing access to the one or more private applications via an on-site disaster recovery system including a site controller, wherein providing the access via the site controller does not require communication with the cloud-based system (step 2706).

The process 2700 can further include wherein prior to activation of disaster recovery mode, the access is provided through the cloud-based system, and after activation of disaster recovery mode, the access is provided through the on-site disaster recovery system, wherein the on-site disaster recovery system comprises the site controller, one or more Private Service Edges (PSEs), and one or more application connectors. After activation of disaster recovery mode, the providing access through the on-site disaster recovery system can include routing application requests through the site controller, a PSE of a plurality of PSEs, and an application connector of a plurality of application connectors. The site controller can be adapted to perform user authentication, Security Assertion Markup Language (SAML) authentication, and policy enforcement. The site controller can be adapted to balance traffic to the plurality of PSEs. The plurality of PSEs can be adapted to route traffic to appropriate application connectors. The one or more criteria can include detecting that the cloud-based system is not responsive.

In various embodiments the process can be performed by a user device having a unified agent application executing thereon. Based on this, the process executed by the user device can include providing access to one or more private applications through a cloud-based system via a unified agent application executing on the user device; detecting one or more criteria suggesting an outage of the cloud-based system; and responsive to activation of a disaster recovery mode based on the one or more criteria, providing access to the one or more private applications via an on-site disaster recovery system including a site controller, wherein providing the access via the site controller does not require communication with the cloud-based system. After activation of disaster recovery mode, the providing access through the on-site disaster recovery system can include routing application requests from the user device through the site controller, a PSE of a plurality of PSEs, and an application connector of a plurality of application connectors. Detecting the one or more criteria can include determining via the unified agent application that the cloud-based system is unreachable, and connecting to the on-site disaster recovery system based thereon. Determining that the cloud-based system is unreachable can be based on a connection being idle for a preconfigured period of time. The unified agent application can be adapted to create a connection with a site controller associated with a specific site based on a user's location. The unified agent application can be adapted to transition between the cloud-based system and the on-site disaster recovery system for providing access to private applications.

### Private Cloud for Access Continuity

The present disclosure further relates to systems and methods for providing a fault-isolated private cloud infrastructure on a per-customer basis. This innovative approach enables customers/tenants of the cloud-based system 100 to maintain seamless business operations with consistent data availability and enhanced cyber protection, even in the event of catastrophic failures impacting standard production cloud environments. Unlike traditional backup solutions, which merely replicate data to a secondary data center, the disclosed system constitutes a fully functional and independent backup cloud. This backup cloud is pre-configured and operationally distinct from the primary production cloud, offering an unparalleled level of fault isolation and business continuity assurance.

Disaster Recovery (DR) features have traditionally focused on enabling users to access their most critical business applications and maintain operational continuity during unexpected disruptions in their production environments. While such DR solutions have proven effective and achieved significant adoption, the traditional approach often comes with inherent compromises. Specifically, conventional DR strategies rely on bypassing the standard cloud infrastructure and security inspection models. In practice, when DR is triggered, the system switches traffic flow away from the primary cloud environment and allows access to a predefined list of trusted domains. These domains are either recommended by default or manually configured by administrators within a Disaster Recovery Proxy Auto-Configuration (DR PAC) file associated with the agent application 350. This approach enables rapid failover and uninterrupted access to essential services but necessitates a tradeoff between continuity and security, as the inspection and enforcement layers designed to monitor and secure data flow are intentionally bypassed during the activation of DR protocols.

To address these challenges and offer customers a solution that delivers both operational continuity and security consistency, the present invention introduces a novel “Private Business Continuity Cloud” solution. This advanced system combines the benefits of private service edges, dedicated private cloud nodes provisioned for customers, and a fully functional private cloud including private policy caches. Together, these elements ensure that all customer configurations, policies, and security enforcement mechanisms are readily accessible and remain operational even in the event of a complete outage of the primary production environment. Unlike traditional solutions that disregard security protocols during DR events, the private business continuity cloud maintains security and functional consistency while facilitating seamless failover and business continuity. By integrating fault isolation, real-time policy enforcement, and reduced tradeoffs between operational priorities, the disclosed system fundamentally redefines the scope of disaster recovery to encompass both continuity and cyber resilience without compromise. This innovation ensures customers can sustain critical business workflows, maintain stringent security protocols, and adhere to organizational or regulatory policies, even in the face of major infrastructure outages.

The disclosed system is designed with fault isolation as a core principle to ensure the operational independence of the private cloud from the global/public cloud infrastructure (the cloud-based system 100). This architecture eliminates shared points of failure between the two environments, thereby ensuring that the private cloud does not inherit the same vulnerabilities or disruptions that may impact the global cloud. In other words, even if the global cloud experiences a catastrophic failure, such as widespread downtime caused by hardware malfunctions, software bugs, cyberattacks, or power outages, the private cloud will remain fully functional and accessible, allowing customers to maintain business continuity without interruption.

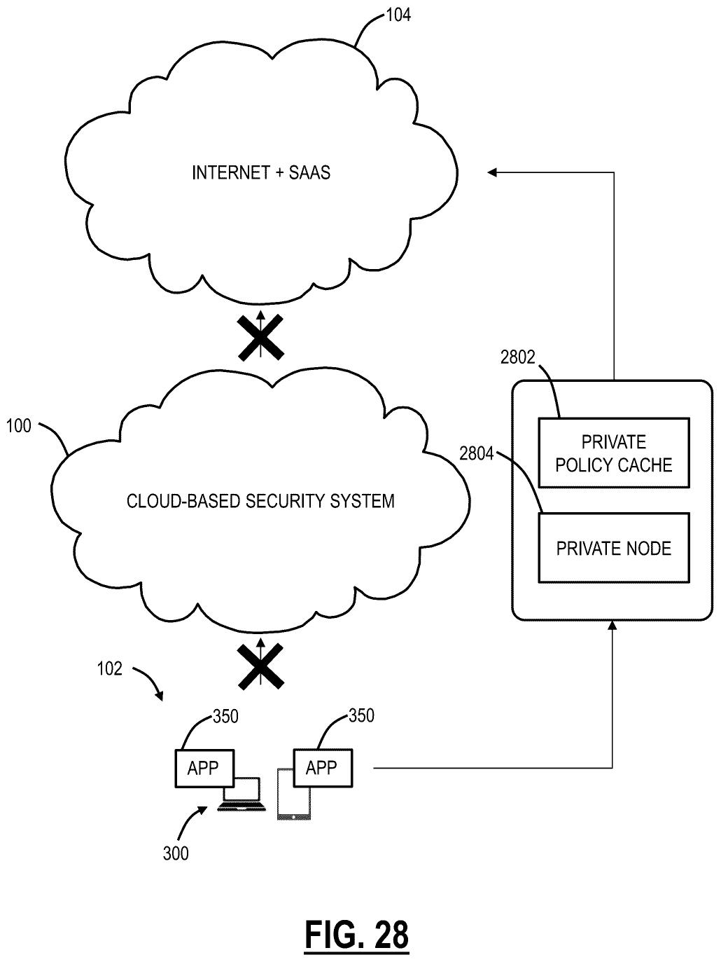

FIG. 28 is a diagram of an architecture for providing access to the internet and SaaS applications via a private cloud. The present invention incorporates a private policy cache 2802 designed to enhance resiliency and enforce organization-specific policies without compromising overall system throughput. The private policy cache 2802 is strategically co-located on a dedicated node box or physical machine within a customer-specific sub-cloud environment. This deployment ensures that policy enforcement and configuration retrieval occur efficiently, even under stress conditions, without introducing performance bottlenecks or throughput limitations. Furthermore, the private policy cache 2802 operates within a Natted IP space to maintain security and isolation standards, preventing external interference and ensuring compliance with organizational network policies.

For robustness and ease of scalability, the private policy cache 2802 is equipped with a full prefetched cache tailored to specific organization IDs. This prefetched configuration allows the system to preload critical policies and configurations for a designated customer, ensuring rapid access and enforcement during runtime. To bolster reliability and survivability in the event of machine reboots, which, although rare, may occasionally occur, the prefetched configurations are stored persistently on disk rather than in shared memory. This disk-based approach ensures the integrity and availability of organizational policies, even when the underlying hardware or software undergoes restarts or maintenance operations.

To facilitate seamless customer-specific interactions, the private policy cache 2802 is assigned to a sub-cloud distinguished by a unique Fully Qualified Domain Name (FQDN), such as route.customer1.zscalertwo.net. This domain-based mapping enables precise addressing and identification of individual customer environments while simplifying communication and policy management workflows. In typical deployment scenarios, each physical node cluster is paired with a single set of private policy cache instances. This pairing ensures localized communication within the cluster, with all nodes communicating over a local network directly with the assigned private policy cache 2802. Such a setup avoids reliance on cross-Data Center (cross-DC) connectivity, thereby reducing latency, minimizing infrastructure dependencies, and improving failover efficiency.

The customer agent applications 350 are specifically designed and adapted to seamlessly manage failover and failback operations between the public (global) cloud and the managed private cloud, ensuring uninterrupted business continuity in changing availability scenarios. When a disruption or failure is detected in the public cloud, the agent application 350 automatically initiates a failover process to redirect traffic, connections, and workloads to the preconfigured managed private cloud. This transition occurs without requiring manual intervention, enabling customers to continue accessing critical applications and services with minimal latency or downtime. The agent's intelligence ensures that all established policies, configurations, and routing mechanisms are dynamically adjusted to accommodate the failover, maintaining consistency in functionality and security.

Equally important, when the public cloud regains its availability and operational state, the customer agent applications 350 are adapted to perform an automated failback to the global cloud environment, i.e., the cloud-based system 100. This failback process restores normal operations while ensuring that any data, configuration, or processes executed in the private cloud during the failover period are synchronized appropriately with the public cloud. The agent monitors the health and status of both cloud environments in real-time, leveraging advanced detection mechanisms and failback logic to initiate transitions at the earliest viable opportunity, thereby maximizing overall system reliability and performance.

In various embodiments, the system includes an administrative portal that enables administrators to monitor and manage the private infrastructure inventory through a dedicated interface. This dedicated private infrastructure page provides a comprehensive view of all private infrastructure instances deployed as part of the managed private cloud architecture. For each customer-specific sub-cloud environment, the portal displays detailed information about the private nodes 2804 and their corresponding private policy cache 2802 instances, allowing administrators to quickly assess the layout, status, and configuration of the private components.

Notably, the portal is designed to show the mappings between private nodes and their associated private policy caches 2802, providing critical insight into how infrastructure elements interact within the system. This clear and concise representation of node-to-cache associations enhances manageability by allowing administrators to verify that the system's policy enforcement and control channels are configured correctly. Additionally, the portal supports monitoring features that can highlight the health and performance of each private infrastructure instance, ensuring that faults, resource constraints, or other anomalies can be promptly identified and addressed.

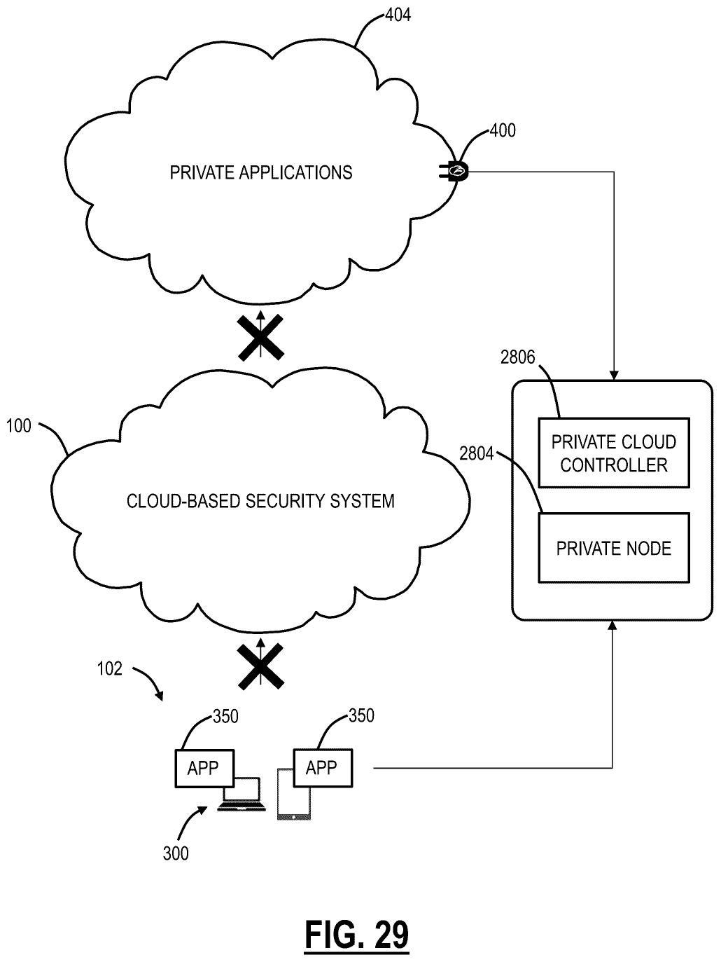

FIG. 29 is a diagram of an architecture for providing access to private applications via a private cloud. When implementing the private cloud to enable secure access to private applications 404 during a public (global) cloud outage, the private cloud infrastructure includes two critical components: the private node 2804 and the private cloud controller 2806. The private node 2804 acts as a dedicated computing resource tailored for customer-specific workloads, while the private cloud controller 2806 serves as the centralized management and control entity within the private cloud architecture. The private cloud controller 2806 delivers several essential services to ensure the continuity, functionality, and security of customer operations. These services include authentication of users 102 and devices 300, load balancing to optimize the distribution of workload across the private cloud infrastructure, synchronization of configurations with the global cloud to maintain consistency during normal operations, new user enrollment to accommodate provisioning needs, and real-time log streaming for monitoring and diagnostics.

In DR mode, when the public cloud becomes unavailable, the private cloud controller 2806 takes on pivotal responsibilities to ensure uninterrupted access to private applications 404 while maintaining stringent security measures. Specifically, during such outages, the private cloud controller 2806 enforces zero trust policies, ensuring that access to private applications remains governed by strict identity verification, access controls, and least-privileged principles. It also supports authentication and enrollment services, enabling the onboarding of new users and devices into the private cloud ecosystem even during DR operations. Additionally, the private cloud controller 2806 facilitates automated failover between the global cloud and the private cloud, ensuring a smooth transition for customer workflows and maintaining business continuity with minimal operational impact.

Furthermore, application connectors 400 within the private cloud environment rely heavily on the private cloud controller 2806 during DR mode. These application connectors 400 interact with the private cloud controller 2806 for vital functions such as downloading updated configurations, logging traffic and activity for compliance and diagnostic purposes, and authenticating user or application sessions. This tight integration between the application connectors and the private cloud controller 2806 ensures that all critical processes remain functional and securely manageable, even when primary cloud infrastructure is offline.

The private cloud controller 2806 serves as a robust, resilient, and centralized mechanism within the private cloud architecture, empowering organizations to maintain secure and reliable access to private applications during cloud outages while adhering to high standards of security, operational consistency, and scalability.

In various embodiments, the disclosed system consolidates the components and functionalities required for providing secure and uninterrupted access to the internet, SaaS (Software-as-a-Service) applications, and private applications into a unified solution referred to as a “hosted private cloud” for a customer. This hosted private cloud serves as a dedicated, customer-specific environment that integrates all the necessary infrastructure and services to support seamless connectivity and application access under both normal operating conditions and during disruptions to the global cloud. By centralizing these capabilities within a single hosted private cloud, the system eliminates the complexity and overhead associated with managing separate environments for different types of applications, while ensuring fault-isolated and secure operations distinct from the shared global cloud infrastructure.

The hosted private cloud is architected to deliver holistic and cohesive functionality by incorporating secure internet access gateways, robust SaaS application integrations, and private application access mechanisms. This all-in-one approach ensures that customers can rely on a single, highly resilient private cloud for all their connectivity and application needs, without the need for multiple failover or configuration strategies for different services. Moreover, the private cloud is tailored to customer-specific policies and configurations, including security requirements, traffic routing, access controls, and load balancing preferences. These customizations empower customers with both flexibility and control over their hosted environments.

By encapsulating the functionalities for internet, SaaS, and private application access into a single hosted private cloud, the system provides an efficient, scalable, and secure solution that enhances business continuity and customer experience. This design aligns with modern requirements for hybrid cloud architectures and ensures that customers benefit from consistent performance, zero trust security principles, and operational reliability, regardless of whether the global cloud is available or experiencing an outage.

The disclosed disaster recovery system is designed to ensure seamless access to the internet, SaaS applications, and private applications during a global cloud outage by leveraging a hosted private cloud. When an outage occurs, customer agent applications 350 proactively detect disruptions in the public cloud through periodic monitoring, such as heartbeat signals and API health checks. Once an outage is identified, the system automatically transitions to DR mode, redirecting all traffic from the public cloud to the private cloud infrastructure via automated failover mechanisms. During this transition, DNS mappings are adjusted, and customer-specific policies, pre-synchronized between the global cloud and private cloud, are enforced to maintain consistency in security and access controls. All traffic is routed through the private node 2804 of the hosted private cloud, which governs internet access by inspecting and validating requests against configured policies, allowing only approved domains while blocking unauthorized destinations. Zero trust authentication policies are applied based on the private policy cache 2802, ensuring secure identity verification and access governance for users accessing the internet or SaaS applications like email platforms, CRM systems, or collaboration tools.

For private applications 404, application connectors 400 installed on the customer's infrastructure (such as on-premises or hybrid systems) communicate directly with the private cloud controller 2806 to download configurations, authenticate users, provide a connection, and stream logs for compliance monitoring. The private cloud controller 2806 ensures secure access to private applications hosted within the customer's environment by enforcing strict role-based and least-privilege access policies. These policies are consistently maintained during DR mode using persistently stored configurations on disk, which guarantee operational survivability even in the event of machine reboots or system disruptions. Moreover, the private cloud architecture eliminates latency concerns by localizing communication between private nodes 2804 and private policy caches 2802, ensuring reliable operation without dependence on cross-data center connectivity. Throughout DR mode, the system dynamically balances workloads across the private cloud infrastructure to optimize performance and prevent service degradation.

Once the public cloud regains availability, the system initiates automated failback procedures. Customer agent applications 350 detect restoration of the global cloud and redirect traffic back to the public cloud environment while synchronizing any changes, logs, or configurations from the private cloud to ensure consistency. This seamless failback process allows business operations to return to normal without interruption, while the private cloud resumes its standby role, ready to mitigate future disruptions. With its ability to provide uninterrupted access to the internet, SaaS applications, and private applications under stringent security policies, the hosted private cloud ensures robust business continuity and operational resilience during outages.

It will be understood and appreciated that the systems and methods described herein may be integrated or used in conjunction with any of the previously discussed systems and methods for ensuring or maintaining access in the event of a cloud service outage. Such integration may enhance system resilience, provide redundant access pathways, or improve the continuity of operations during periods of reduced or lost connectivity to cloud-based resources.

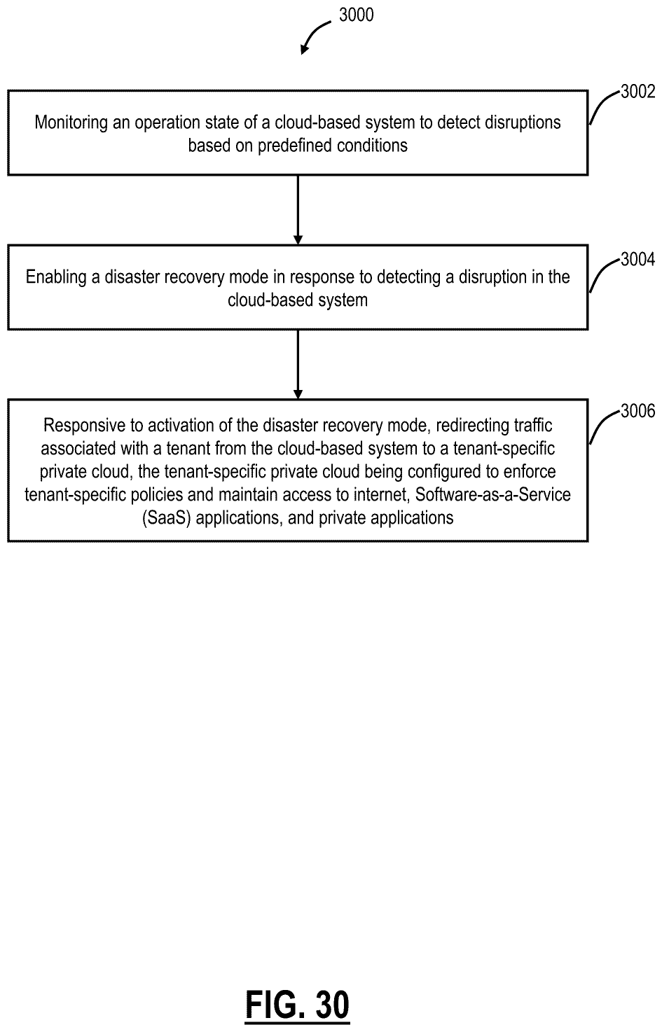

FIG. 30 is a flowchart of a process for providing access continuity via tenant-specific private clouds. The process 3000 includes monitoring an operation state of a cloud-based system to detect disruptions based on predefined conditions (step 3002); enabling a disaster recovery mode in response to detecting a disruption in the cloud-based system (step 3004); and responsive to activation of the disaster recovery mode, redirecting traffic associated with a tenant from the cloud-based system to a tenant-specific private cloud, the tenant-specific private cloud being configured to enforce tenant-specific policies and maintain access to internet, Software-as-a-Service (SaaS) applications, and private applications (step 3006).

The process 3000 can further include wherein prior to activation of disaster recovery mode, the access is provided through the cloud-based system, and after activation of disaster recovery mode, the access is provided through the tenant-specific private cloud, wherein the tenant-specific private cloud includes a private node, a private policy cache, and a private cloud controller. Monitoring the operation state of the cloud-based system can include performing periodic health checks with heartbeat signals and detecting disruptions by evaluating response timeout thresholds and error conditions. The steps can include synchronizing tenant-specific policies and configurations between the cloud-based system and the tenant-specific private cloud. Redirecting traffic can include modifying Domain Name Service (DNS) records to route tenant traffic to a Fully Qualified Domain Name (FQDN) associated with the tenant-specific private cloud. The steps can include authenticating users and devices accessing the tenant-specific private cloud and providing least-privilege access controls for private applications via the private cloud. The tenant-specific private cloud can be configured to provide authentication services, facilitate load balancing among private cloud resources, stream activity logs from the private cloud to a storage solution, and synchronize policies and configurations with the cloud-based system while disaster recovery mode is inactive. The steps can include detecting restoration of the cloud-based system and initiating a failback procedure to redirect tenant traffic from the tenant-specific private cloud back to the cloud-based system. The failback procedure can synchronize logs, configurations, and policies from the tenant-specific private cloud to the cloud-based system before redirection. The steps can include providing access to private applications of the tenant through one or more application connectors, wherein the one or more application connectors are adapted to facilitate a connection through a private cloud controller of the tenant specific private cloud.

### CONCLUSION

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device such as hardware, software, firmware, and a combination thereof can be referred to as “circuitry configured or adapted to,” “logic configured or adapted to,” etc. perform a set of operations, steps, methods, processes, algorithms, functions, techniques, etc. as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read-Only Memory), an EPROM (Erasable Programmable Read-Only Memory), an EEPROM (Electrically Erasable Programmable Read-Only Memory), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A non-transitory computer-readable medium including instructions that, when executed, cause one or more processors to perform steps of:
monitoring an operation state of a cloud-based system to detect disruptions based on predefined conditions;
enabling a disaster recovery mode in response to detecting a disruption in the cloud-based system; and
responsive to activation of the disaster recovery mode, redirecting traffic associated with a tenant from the cloud-based system to a tenant-specific private cloud, the tenant-specific private cloud being configured to enforce tenant-specific policies and maintain access to internet, Software-as-a-Service (SaaS) applications, and private applications.

2. The non-transitory computer-readable medium of claim 1, wherein prior to activation of disaster recovery mode, the access is provided through the cloud-based system, and after activation of disaster recovery mode, the access is provided through the tenant-specific private cloud, wherein the tenant-specific private cloud comprises a private node, a private policy cache, and a private cloud controller.

3. The non-transitory computer-readable medium of claim 1, wherein monitoring the operation state of the cloud-based system includes performing periodic health checks with heartbeat signals and detecting disruptions by evaluating response timeout thresholds and error conditions.

4. The non-transitory computer-readable medium of claim 1, wherein the steps comprise synchronizing tenant-specific policies and configurations between the cloud-based system and the tenant-specific private cloud.

5. The non-transitory computer-readable medium of claim 1, wherein redirecting traffic includes modifying Domain Name Service (DNS) records to route tenant traffic to a Fully Qualified Domain Name (FQDN) associated with the tenant-specific private cloud.

6. The non-transitory computer-readable medium of claim 1, wherein the steps include authenticating users and devices accessing the tenant-specific private cloud and providing least-privilege access controls for private applications via the private cloud.

7. The non-transitory computer-readable medium of claim 1, wherein the tenant-specific private cloud is configured to provide authentication services, facilitate load balancing among private cloud resources, stream activity logs from the private cloud to a storage solution, and synchronize policies and configurations with the cloud-based system while disaster recovery mode is inactive.

8. The non-transitory computer-readable medium of claim 1, wherein the steps include detecting restoration of the cloud-based system and initiating a failback procedure to redirect tenant traffic from the tenant-specific private cloud back to the cloud-based system.

9. The non-transitory computer-readable medium of claim 8, wherein the failback procedure synchronizes logs, configurations, and policies from the tenant-specific private cloud to the cloud-based system before redirection.

10. The non-transitory computer-readable medium of claim 1, wherein the steps include providing access to private applications of the tenant through one or more application connectors, wherein the one or more application connectors are adapted to facilitate a connection through a private cloud controller of the tenant-specific private cloud.

11. A method comprising steps of:
monitoring an operation state of a cloud-based system to detect disruptions based on predefined conditions;
enabling a disaster recovery mode in response to detecting a disruption in the cloud-based system; and
responsive to activation of the disaster recovery mode, redirecting traffic associated with a tenant from the cloud-based system to a tenant-specific private cloud, the tenant-specific private cloud being configured to enforce tenant-specific policies and maintain access to internet, Software-as-a-Service (SaaS) applications, and private applications.

12. The method of claim 11, wherein prior to activation of disaster recovery mode, the access is provided through the cloud-based system, and after activation of disaster recovery mode, the access is provided through the tenant-specific private cloud, wherein the tenant-specific private cloud comprises a private node, a private policy cache, and a private cloud controller.

13. The method of claim 11, wherein monitoring the operation state of the cloud-based system includes performing periodic health checks with heartbeat signals and detecting disruptions by evaluating response timeout thresholds and error conditions.

14. The method of claim 11, wherein the steps comprise synchronizing tenant-specific policies and configurations between the cloud-based system and the tenant-specific private cloud.

15. The method of claim 11, wherein redirecting traffic includes modifying Domain Name Service (DNS) records to route tenant traffic to a Fully Qualified Domain Name (FQDN) associated with the tenant-specific private cloud.

16. The method of claim 11, wherein the steps include authenticating users and devices accessing the tenant-specific private cloud and providing least-privilege access controls for private applications via the private cloud.

17. The method of claim 11, wherein the tenant-specific private cloud is configured to provide authentication services, facilitate load balancing among private cloud resources, stream activity logs from the private cloud to a storage solution, and synchronize policies and configurations with the cloud-based system while disaster recovery mode is inactive.

18. The method of claim 11, wherein the steps include detecting restoration of the cloud-based system and initiating a failback procedure to redirect tenant traffic from the tenant-specific private cloud back to the cloud-based system.

19. The method of claim 18, wherein the failback procedure synchronizes logs, configurations, and policies from the tenant-specific private cloud to the cloud-based system before redirection.

20. The method of claim 11, wherein the steps include providing access to private applications of the tenant through one or more application connectors, wherein the one or more application connectors are adapted to facilitate a connection through a private cloud controller of the tenant-specific private cloud.
